(19) United States
(12) Patent Application Publication
(10) Pub. No.: US 2021/0228977 A1
(43) Pub. Date: Jul. 29, 2021

(54) INFORMATION PROCESSING APPARATUS, INFORMATION PROCESSING METHOD, AND PROGRAM

(71) Applicant: SONY CORPORATION, TOKYO (JP)

(72) Inventors: TAKASHI ABENO, TOKYO (JP); RYUZO NAKATA, TOKYO (JP)

(21) Appl. No.: 17/051,539

(22) PCT Filed: Apr. 1, 2019
(86) PCT No.: PCT/JP2019/014436

§ 371 Date: Oct. 29, 2020

(30) Foreign Application Priority Data
May 7, 2018 (JP) 2018-089381

(51) Int. Cl. A63F 13/213; G06K 7/10

(52) U.S. Cl. CPC A63F 13/213; G06K 7/10366

(57) ABSTRACT

[Problem] There is desired to provide a technology that is capable of appropriately complementing unknown identification information. [Solution] There is provided an information processing apparatus including a processing unit configured to determine, when identification information of a first object that is detected at a first timing is read and further when identification information of a second object that is detected at a second timing different from the first timing is not read, that the first object and the second object are a same to each other.

### FIELD

The present disclosure relates to an information processing apparatus, an information processing method, and a program.

### BACKGROUND

Recently, there has been known a technology that reads identification information from an object placed on a detection region so as to execute a predetermined process on the basis of the read identification information. For example, there has been disclosed a technology that reads user identification information from an object placed on a detection region so as to execute user authentication on the basis of the read user identification information and preliminary-registered user identification information (see Patent Literature 1, for example).

### CITATION LIST

### Patent Literature

Patent Literature 1: JP 2004-054914 A

### SUMMARY

### Technical Problem

However, within a detection region, there may be present a region (hereinafter, may be referred to as “unreadable region”) in which identification information is not able to be read from an object. When an object is placed on the unreadable region, a process according to identification information of the object is not able to be executed. Thus, there has been desired a technology that is capable of appropriately complementing unknown identification information.

### Solution to Problem

According to the present disclosure, an information processing apparatus is provided. The information processing apparatus includes a processing unit configured to: when identification information of a first object that is detected at a first timing is read and further when identification information of a second object that is detected at a second timing different from the first timing is not read, determine that the first object and the second object are a same to each other.

According to the present disclosure, an information processing method is provided. The information processing method allows a processor to execute the following step: when identification information of a first object that is detected at a first timing is read and further when identification information of a second object that is detected at a second timing different from the first timing is not read, determining that the first object and the second object are a same to each other.

According to the present disclosure, a program is provided. The program allows a computer to function as an information processing apparatus including: a processing unit that determines, when identification information of a first object that is detected at a first timing is read and further when identification information of a second object that is detected at a second timing different from the first timing is not read, that the first object and the second object are a same to each other.

### Advantageous Effects of Invention

As described above, according to the present disclosure, it is possible to appropriately complement unknown identification information. The above-described effects are not necessarily limited, and any effects indicated in the present specification or other effects that can be understood from the present specification may be exerted together with or instead of the above-described effects.

### BRIEF DESCRIPTION OF DRAWINGS

FIG. 1 is a diagram illustrating an exterior configuration example of an information processing system according to the present embodiment.

FIG. 2 is a diagram illustrating one example of a state where a single user plays a game by using the information processing system according to the present embodiment.

FIG. 3 is a diagram illustrating one example of an overall configuration of the information processing system according to the present embodiment.

FIG. 4 is a diagram illustrating one example of a functional configuration of a game console according to a first embodiment of the present disclosure.

FIG. 5 is a diagram illustrating one example of a functional configuration of a pad device according to the first embodiment.

FIG. 6 is a diagram illustrating one example of a functional configuration of a card according to the first embodiment.

FIG. 7 is a diagram illustrating one example of a functional configuration of a server device according to the first embodiment.

FIG. 8 is a diagram illustrating an example of downloading of a card-information complementing program from the server device.

FIG. 9 is a diagram illustrating a first example of a card-information complementing process.

FIG. 10 is a diagram illustrating a second example of the card-information complementing process.

FIG. 11 is a diagram illustrating a third example of the card-information complementing process.

FIG. 12 is a diagram illustrating a fourth example of the card-information complementing process.

FIG. 13 is a diagram illustrating a fifth example of the card-information complementing process.

FIG. 14 is a diagram illustrating a sixth example of the card-information complementing process.

FIG. 15 is a diagram illustrating a seventh example of the card-information complementing process.

FIG. 16 is a diagram illustrating an eighth example of the card-information complementing process.

FIG. 17 is a flowchart illustrating an example of operation of the information processing system according to the first embodiment of the present disclosure.

FIG. 18 is a flowchart illustrating details of the card-information complementing process according to the first embodiment.

FIG. 19 is a flowchart illustrating details of the card-information complementing process according to the first embodiment.

FIG. 20 is a diagram illustrating a ninth example of the card-information complementing process.

FIG. 21 is a diagram illustrating a tenth example of the card-information complementing process.

FIG. 22 is a diagram illustrating an eleventh example of the card-information complementing process.

FIG. 23 is a diagram illustrating a twelfth example of the card-information complementing process.

FIG. 24 is a flowchart illustrating details of a card-information complementing process according to a second embodiment of the present disclosure.

FIG. 25 is a diagram illustrating a thirteenth example of the card-information complementing process.

FIG. 26 is a flowchart illustrating an example of operation of an information processing system according to a third embodiment of the present disclosure.

FIG. 27 is a flowchart illustrating details of a card-information complementing process according to the third embodiment.

### DESCRIPTION OF EMBODIMENTS

The following describes preferable embodiments of the present disclosure in detail with reference to the attached drawings. In the present specification and the drawings, overlap of descriptions will be avoided by providing the same reference symbols for constituent elements having substantially the same functional configuration.

In the present specification and the drawings, a plurality of constituent elements having substantially the same or a similar functional configuration may be differentiated by providing thereto different numbers after the same reference symbol. Note that the same reference symbol alone is provided to the plurality of constituent elements having substantially the same or a similar functional configuration in a case where there presents no need for particularly differentiating them. Furthermore, similar constituent elements according to different embodiments may be differentiated by providing thereto different alphabet-letters after the same reference symbol. Note that the same reference symbol alone is provided to the similar constituent elements in a case where there presents no need for particularly differentiating them.

Descriptions will be constituted in the following order.
0. Outline of Information Processing System
1. First Embodiment
2. Second Embodiment
3. Third Embodiment
4. Conclusion

### 0. Outline of Information Processing System

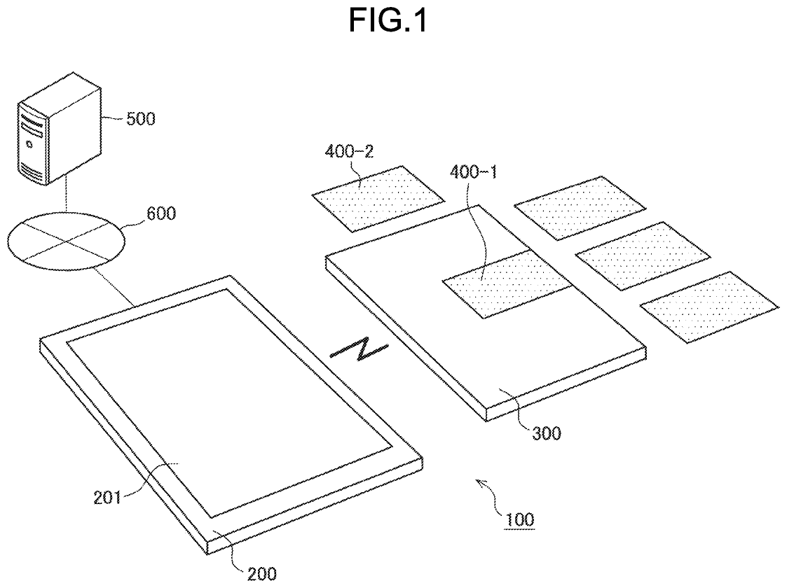

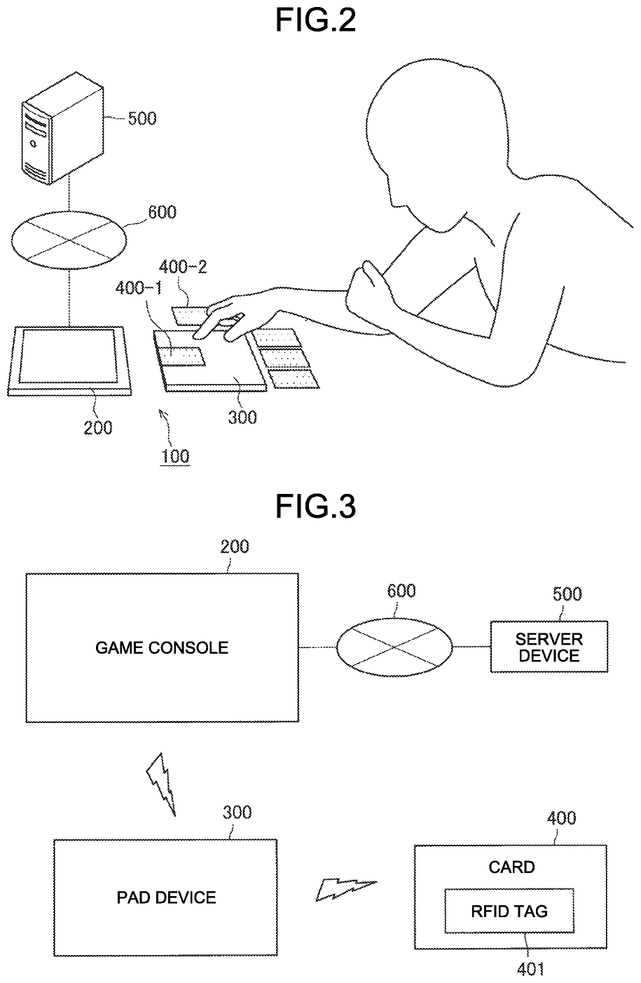

FIG. 1 is a diagram illustrating an exterior configuration example of an information processing system 100 that is capable of executing application of a game and the like by using a short-range wireless communication technology. FIG. 2 is a diagram illustrating one example of a state where a single user plays a game by using the information processing system 100. The illustrated information processing system 100 includes a game console 200, a pad device 300, cards 400, and a server device 500.

The game console 200 is constituted of a widely-used information terminal such as a smartphone and a tablet, so as to execute application. An upper surface of the game console 200 is configured to be a screen 201 that displays images of a game. The screen 201 may be a touch-panel display, and a user who is a player of a game is able to directly perform an input operation on the screen 201 by using his/her fingertip. In the present embodiment, a case is mainly supposed in which application is executed by the game console 200.

On the other hand, the pad device 300 is a plate-shaped device on which a user who is a player of a game performs an operation such as placing cards 400-1, 400-2, . . . thereon that are corresponding to a character, a weapon, and booty. As described below, in the pad device 300, antennae and coils for communicating with a radio frequency identification (RFID) tag embedded in each of the cards 400-1, 400-2, . . . are arranged in two-dimensional array-shaped.

The pad device 300 may be considered as an auxiliary device of an information terminal. The game console 200 and the pad device 300 are connected to each other by using wireless communication such as Bluetooth (Registered Trademark). Needless to say, a mode may be employed in which the game console 200 and the pad device 300 are connected in a wired manner by using a cable of Universal Serial Bus (USB) and the like. The game console 200 is supposed to be connected to a wide area network 600 such as the Internet via Wireless Fidelity (Wi-Fi: Registered Trademark) or an Ethernet (Registered Trademark) cable.

The server device 500 is constituted of a computer, and is connected to the wide area network 600 via a cable. In the present embodiment, a case is mainly supposed in which the server device 500 provides a program to the game console 200 in response to a request from the game console 200. However, the server device 500 may provide a program to the game console 200 regardless of presence/absence of a request from the game console 200. Details of a program to be provided from the server device 500 to the game console 200 will be described later.

(Game Merged with Entity)

In the present embodiment, characters, weapons, booty, etc. that are used in a digital game, namely, digital information that is originally virtual is able to be handled as tangible objects such as cards and figures, so that it is possible to merge a digital game executed by the game console 200 with a game using entities.

For example, when RFID tags are built in or embedded in tangible objects such as a card and a figure, and a user who is a player of a game appropriately places a card or a figure on the pad device 300 while playing the game, the game console 200 is capable of reading information from a RFID tag in a card or a figure, or rewriting information of the RFID tag via the pad device 300 in accordance with progress of the game being played (growth of character, attrition of weapon, acquisition of booty, and the like).

In the present embodiment, for convenience of explanation, a game to be explained is mainly supposed to be a game using cards. On surfaces of the cards, pictures that indicate corresponding characters, weapons, booty, etc. are supposed to be drawn by face printing and the like. In consideration of application in which a turned-over card is also used, pictures may be drawn on both surfaces of the card. Note that the cards are supposed to be made of paper; needless to say, the cards may be made of resin, or may be laminate-processed cards.

In the examples illustrated in FIGS. 1 and 2, a single user enjoys a game executed on the game console 200 while operating cards on the pad device 300; however, the number of users of the game is not limited to one. Two or more users may join the game executed on the game console 200 while operating cards by using the pad devices 300 dedicated to the respective users. In other words, a usage form may be employed in which the pad device 300 is additionally provided for each participant in the game.

(Background)

As described above, in the pad device 300, antennae and coils for communicating with a RFID tag embedded in each of the cards 400-1, 400-2, . . . are arranged in two-dimensional array-shaped. In the present embodiment, in the pad device 300, a case is supposed in which a total of six antennae and coils are arranged so as to form three columns in a long-side direction (X-direction) and two rows in a short-side direction (Y-direction). However, arrangement of the antennae and the coils is not particularly limited. When the card 400 is placed within a communicatable range, the antenna and the coil read information on a RFID tag embedded in the placed card 400. The information on a RFID tag includes identification information (Hereinafter, may be simply referred to as “ID”) of the card 400.

On the other hand, the pad device 300 includes a sensor that is capable of detecting the cards 400 placed on a detection region (upper surface) thereof. In the present embodiment, a case is mainly supposed in which the pad device 300 includes an electrostatic capacity sensor as an example of the sensor that is capable of detecting the cards 400. However, the sensor that is capable of detecting the cards 400 is not limited to the above-mentioned example. In the present embodiment, a case is supposed in which the pad device 300 includes 60 electrostatic capacity sensors. However, the number of electrostatic capacity sensors is not particularly limited.

In the present embodiment, a case is supposed in which up to the four cards 400 are allowed to be placed on the pad device 300. However, the maximum number of the cards 400 to be placed on a detection region of the pad device 300 may be appropriately changed in accordance with a size of the detection region of the pad device 300.

The detection region of the pad device 300 may include a region (unreadable region) in which the card 400 (for example, position and orientation of card 400) is able to be detected but an ID of the card 400 is not able to be read due to arrangement of electrostatic capacity sensors, antennae, and/or coils. When the card 400 is placed on the above-mentioned unreadable region, a process according to the ID of the card 400 is not able to be executed. Thus, in the present embodiment, a technology for appropriately complementing an unknown ID will be mainly explained.

In the present embodiment, the card 400 will be explained as an example of an object to be placed on the pad device 300. However, as the object to be placed on the pad device 300, another object may be employed instead of the card 400. For example, the object to be placed on the pad device 300 may be a figure or the like, and it is sufficient that the object is a tangible object.

Next, an overall configuration of the information processing system 100 according to the present embodiment will be explained with reference to FIG. 3. FIG. 3 is a diagram illustrating one example of an overall configuration of the information processing system 100 according to the present embodiment.

As illustrated in FIG. 3, the information processing system 100 according to the present embodiment includes the game console 200, the pad device 300, the card 400, and the server device 500.

(Game Console 200)

The game console 200 is realized by an information processing terminal such as a smartphone and a tablet so as to execute application. However, the server device 500 may execute the application instead of the game console 200. An upper surface of the game console 200 is configured to be the screen 201 that displays images of a game. The screen 201 may be a touch-panel display, and a user who is a player of a game is able to directly perform an input operation on the screen 201 by using his/her fingertip.

The game console 200 may be connected to the wide area network 600 such as the Internet via Wi-Fi (Registered Trademark) or an Ethernet (Registered Trademark) cable so as to mutually communicate with the server device 500 provided on the network 600.

On the basis of information read from a RFID tag 401 in the card 400 placed on the pad device 300 and/or input of a touch operation performed by a user on the pad device 300, the game console 200 controls output of images on the screen 201 and/or sounds to be capable of realizing interaction using images and/or sounds of a game corresponding to the card 400. For example, the game console 200 executes control for causing an image of a character, which corresponds to a picture drawn on a surface of the card 400, to appear on the screen 201.

The game console 200 is capable of realizing interaction using images and/or sounds of a game in response to input of a touch operation performed by a user on the pad device 300 and/or a user operation performed on the card 400 on the pad device 300 such as removing the card 400 from an upper surface of the pad device 300, changing a position of the card 400, moving the card 400 back/forth and right/left, arranging horizontally the card 400, and turning the card 400 over.

For example, the game console 200 controls output of images and/or sounds, such as switching a picture and progress of a game, in response to a type of the card 400 placed on the pad device 300 by a user, a position and/or an orientation of the card 400 placed on the pad device 300, movement of the card 400 on the pad device 300, a tap, a double-tap, a swiping, or a flicking operation performed by a user, etc.

For example, a pointer displayed on the screen 201 of the game console 200 is moved in accordance with a drag operation on the pad device 300 performed by a user using his/her finger, or a tap operation on the pad device 300 performed by a user using his/her finger is recognized as an operation that the user depresses a button displayed at a corresponding position on an operation screen displayed on the screen 201 of the game console 200.

In accordance with progress of a game, the game console 200 is capable of recording, on the RFID tag 401 in the card 400 via the pad device 300, information on a state (extent of growth, feeling, fatigue degree, etc.) of a character and acquired points of the game. More specific configuration of the game console 200 according to the present embodiment will be mentioned later.

(Pad Device 300)

As obvious from FIG. 1, the pad device 300 has a plate-shaped chassis structure, and a chassis thereof is put on a floor or a desk for use so that an operation surface thereof is up, on which a user who is a player of a game places the card 400 corresponding to a character, a weapon, or booty and which receives an operation of moving the card 400 or his/her touch operation. In the pad device 300, antennae and coils for communicating with an RFID tag 401 embedded in each of the cards 400 are arranged in two-dimensional array-shaped. More specific configuration of the pad device 300 according to the present embodiment will be mentioned later.

(Card 400)

The card 400 is, i.e. “IC card” obtained by embedding the RFID tag 401 in a sheet made of nonmetal material such as paper and resin. The RFID tag 401 includes a communicating function module that is capable of performing short-range wireless communication based on a predetermined standard with a non-contact communication unit 340 of the pad device 300, and a storing function (memory) module from and into which the non-contact communication unit 340 is capable of reading and writing information by using the above-mentioned short-range wireless communication. In the card 400, an antenna and a coil for the short-range wireless communication are formed by using a technology such as printing and etching. On one or both of surfaces of the card 400, a picture indicating a character, a weapon, booty, or the like is drawn by face printing, etc. More specific configuration of the card 400 according to the present embodiment will be mentioned later.

As described above, an overall configuration of the information processing system 100 according to embodiments of the present disclosure has been explained. Subsequently, the information processing system 100 according to each embodiment will be explained with reference to the attached drawings.

### 1. First Embodiment

A first embodiment according to the present disclosure will be explained.

(Functional Configuration of Game Console 200)

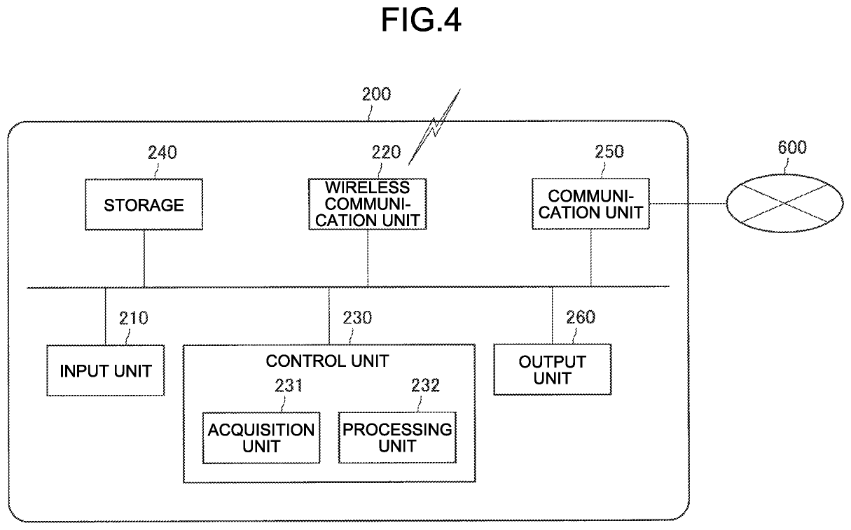

A functional configuration example of the game console 200 according to the first embodiment of the present disclosure will be explained. FIG. 4 is a diagram illustrating one example of a functional configuration of the game console 200 according to the first embodiment of the present disclosure. As illustrated in FIG. 4, the game console 200 according to the first embodiment of the present disclosure includes an input unit 210, a wireless communication unit 220, a control unit 230, a storage 240, a communication unit 250, and an output unit 260.

The input unit 210 has a function of receiving input of operation performed by a user. In the first embodiment according to the present disclosure, a case is mainly supposed in which the input unit 210 includes a touch panel. However, the input unit 210 may include any of a button, a mouse, a keyboard, a switch, and a lever, etc. The input unit 210 may include a microphone that detects voice of a user.

The wireless communication unit 220 is connected to an external device in a wireless manner so as to transmit and receive data. The wireless communication unit 220 and the pad device 300 are connected to each other by using, for example, Bluetooth (Registered Trademark) or Wi-Fi (Registered Trademark) so as to execute information exchange with the pad device 300. Note that connection to the external device and/or transmitting/receiving data to/from the external device may be performed in a wired manner instead of the wireless manner. In this case, the wireless communication unit 220 and the pad device 300 may be connected to each other by using a cable of USB or the like so as to perform information exchange with the pad device 300.

The control unit 230 functions as a calculation processing device and a controller so as to control all the operations of the game console 200 in accordance with various programs. The control unit 230 is realized by an electronic circuit such as a Central Processing Unit (CPU) and a microprocessor. The control unit 230 may include a Read Only Memory (ROM) that stores therein programs and calculation parameters to be used, etc., and a Random Access Memory (RAM) that temporarily stores therein parameters to be appropriately changed, etc. The control unit 230 executes application. The application may be game application and the like. Additionally, the control unit 230 controls an information transmitting/receiving process with the pad device 300 via the wireless communication unit 220.

The storage 240 is realized by a Read Only Memory (ROM) that stores therein programs and calculation parameters to be used in processes of the control unit 230, etc., and a Random Access Memory (RAM) that temporarily stores therein parameters to be appropriately changed, etc.

The communication unit 250 is connected to an external device in a wired or wireless manner so as to transmit and receive data to and from the external device. For example, the communication unit 250 is connected to the wide area network 600 such as the Internet via a cable, so as to perform information exchange with the server device 500 via the wide area network 600.

The output unit 260 outputs various kinds of information. For example, the output unit 260 may include a display that is capable of performing display visually recognized by a user. In this case, the display may be a liquid crystal display or an organic Electro-Luminescence (EL) display.

(Functional Configuration of Pad Device 300)

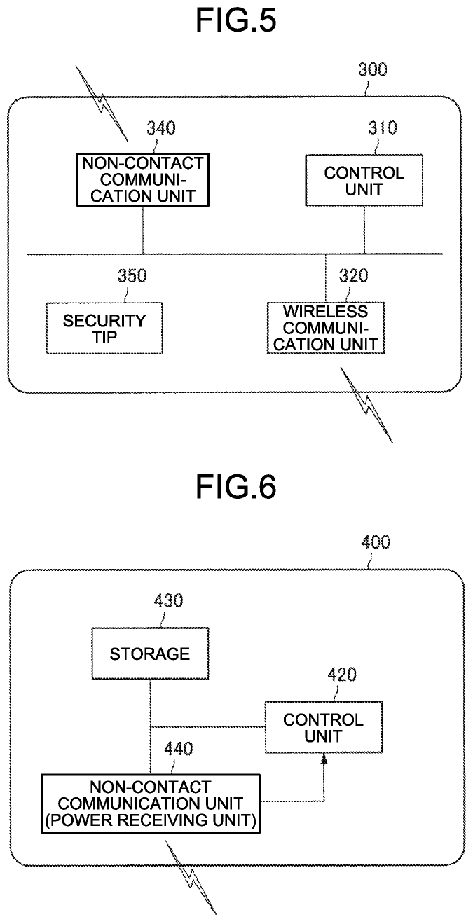

Next, a functional configuration example of the pad device 300 according to the first embodiment of the present disclosure will be explained. FIG. 5 is a diagram illustrating one example of a functional configuration of the pad device 300 according to the first embodiment of the present disclosure. As illustrated in FIG. 5, the pad device 300 according to the first embodiment of the present disclosure includes a control unit 310, a wireless communication unit 320, the non-contact communication unit 340, and a security tip 350. Additionally, the pad device 300 includes a not-illustrated storage. The not-illustrated storage is realized by a Read Only Memory (ROM) that stores therein programs and calculation parameters to be used in processes of the control unit 310, etc., and a Random Access Memory (RAM) that temporarily stores therein parameters to be appropriately changed, etc.

The control unit 310 functions as a calculation processing device and a controller so as to control all the operations of the pad device 300 in accordance with various programs. The control unit 310 is realized by an electronic circuit such as a Central Processing Unit (CPU) and a microprocessor. The control unit 310 may include a Read Only Memory (ROM) that stores therein programs and calculation parameters to be used, etc., and a Random Access Memory (RAM) that temporarily stores therein parameters to be appropriately changed, etc. The control unit 310 controls an information transmitting/receiving process with the game console 200 via the wireless communication unit 320. The control unit 310 controls information reading and writing operations performed on the RFID tag 401 in the cards 400 via the non-contact communication unit 340.

The wireless communication unit 320 is connected to an external device in a wireless manner so as to transmit and receive data. The wireless communication unit 320 and the game console 200 are connected to each other by using, for example, Bluetooth (Registered Trademark) or Wi-Fi (Registered Trademark) so as to execute information exchange with the game console 200. Note that connection to the external device and/or transmitting/receiving data to/from the external device may be performed in a wired manner instead of the wireless manner. In this case, the wireless communication unit 320 and the game console 200 may be connected to each other by using a cable of USB or the like so as to perform information exchange with the game console 200.

The non-contact communication unit 340 includes a plurality of antennae and coils that are arranged in in-plane directions in two-dimensional array-shaped, and is capable of selectively using any of the antennae and the coils so as to read information from a RFID tag in the card 400 that is placed at an arbitrary position on an operation surface and to write information into the RFID tag.

(Functional Configuration of Card 400)

Next, a functional configuration example of the card 400 according to the first embodiment of the present disclosure will be explained. FIG. 6 is a diagram illustrating one example of a functional configuration of the card 400 according to the first embodiment of the present disclosure. As illustrated in FIG. 6, the card 400 according to the first embodiment of the present disclosure includes a control unit 420, a storage 430, and a non-contact communication unit 440.

The control unit 420 is realized by an electronic circuit such as a Central Processing Unit (CPU) and a microprocessor. The control unit 420 may include a Read Only Memory (ROM) that stores therein programs and calculation parameters to be used, etc., and a Random Access Memory (RAM) that temporarily stores therein parameters to be appropriately changed, etc. The control unit 420 acquires data received by the non-contact communication unit 440, and reads/writes data from/into the storage 430.

The non-contact communication unit 440 is a communicating function module that is capable of performing short-range wireless communication based on a predetermined standard with the non-contact communication unit 340 of the pad device 300. The non-contact communication unit 440 additionally has a function as a power receiving unit. In other words, when the non-contact communication unit 440 receives a Radio Frequency (RF) signal, power is supplied to a block (for example, control unit 420) of the card 400 on the basis of the received RF signal. When being placed on the pad, the card 400 is capable of operating by the above-mentioned non-contact power supply without using electric power supplied from a battery, so that it is possible to realize the thin battery-less card 400. On the other hand, the card 400 may operate by using electric power supplied from a battery.

The storage 430 is realized by a Read Only Memory (ROM) that stores therein programs and calculation parameters to be used in processes of the control unit 420, etc., and a Random Access Memory (RAM) that temporarily stores therein parameters to be appropriately changed, etc. The storage 430 may function as a storing function (memory) module from and into which the non-contact communication unit 340 is capable of reading and writing information by using short-range wireless communication using the non-contact communication unit 440.

(Functional Configuration of Server Device 500)

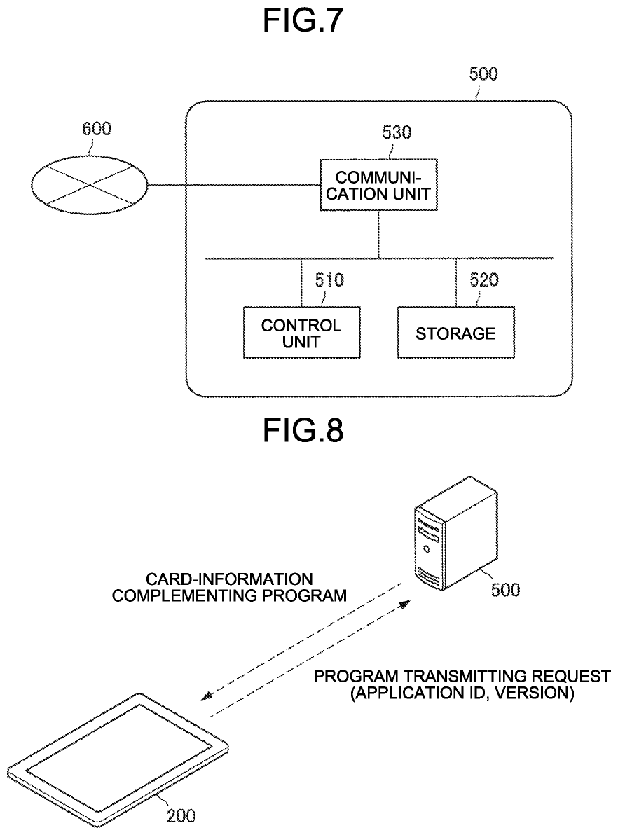

Next, a functional configuration example of the server device 500 according to the first embodiment of the present disclosure will be explained. FIG. 7 is a diagram illustrating one example of a functional configuration of the server device 500 according to the first embodiment of the present disclosure. As illustrated in FIG. 7, the server device 500 according to the first embodiment of the present disclosure includes a control unit 510, a storage 520, and a communication unit 530.

The control unit 510 functions as a calculation processing device and a controller so as to control all the operations of the server device 500 in accordance with various programs. The control unit 510 is realized by an electronic circuit such as a Central Processing Unit (CPU) and a microprocessor. The control unit 510 may include a Read Only Memory (ROM) that stores therein programs and calculation parameters to be used, etc., and a Random Access Memory (RAM) that temporarily stores therein parameters to be appropriately changed, etc. Additionally, the control unit 510 controls an information transmitting/receiving process with the game console 200 via the communication unit 530.

The storage 520 is realized by a Read Only Memory (ROM) that stores therein programs and calculation parameters to be used in processes of the control unit 510, etc., and a Random Access Memory (RAM) that temporarily stores therein parameters to be appropriately changed, etc. The storage 520 stores therein information (user information) related to users, information (card information) related to cards, and the like.

The communication unit 530 is connected to an external device in a wired manner so as to perform transmitting/receiving data to/from the external device. For example, the communication unit 530 is connected to the wide area network 600 such as the Internet via a cable, so as to perform information exchange with the game console 200 via the wide area network 600.

(Download of Program)

As described above, in the present embodiment, a technology that is capable of complementing an unknown ID will be mainly explained. Particularly, in the present embodiment, a case will be mainly explained as an example in which a processing unit 232 of the game console 200 complements an unknown ID. The processing unit 232 carries out its function when a processor executes a program (hereinafter, may be referred to as “card-information complementing program”). The card-information complementing program may be downloaded from another device by an acquisition unit 231. Herein, a case is supposed in which a card-information complementing program is downloaded from the server device 500 by the acquisition unit 231.

FIG. 8 is a diagram illustrating an example of downloading of a card-information complementing program from the server device 500. As illustrated in FIG. 8, the acquisition unit 231 of the game console 200 transmits (for example, on the basis of download starting operation performed by user) a program transmitting request to the server device 500 via the communication unit 250, and downloads a card-information complementing program from the server device 500 as a response to the program transmitting request.

In this case, as illustrated in FIG. 8, an application ID and a version of application may be included in the program transmitting request, and a card-information complementing program corresponding to the application ID and the version of application may be downloaded. Or when an ID of the pad device 300 and a version of the pad device 300 are acquirable, a card-information complementing program corresponding to the ID of the pad device 300 and the version of the pad device 300 may be downloaded.

In the present embodiment, a case will be mainly supposed in which the processing unit 232 and the acquisition unit 231 are integrated into the game console 200. However, the processing unit 232 and the acquisition unit 231 may be integrated into a device other than the game console 200. For example, the processing unit 232 and the acquisition unit 231 may be integrated into the pad device 300. In this case, a card-information complementing program may be downloaded from the server device 500, or may be downloaded from the game console 200.

Alternatively, the processing unit 232 may be integrated into the server device 500. When the processing unit 232 is integrated into the server device 500, a card-information complementing process is expected to be executed with a higher safety. In this case, a card-information complementing program may be preliminarily stored in the server device 500. In this case, the acquisition unit 231 is not necessarily integrated into the server device 500.

When the acquisition unit 231 of the game console 200 acquires a card-information complementing program, a processor executes the card-information complementing program. The card-information complementing program is not necessarily downloaded from another device, and may be preliminarily stored in a device into which the processing unit 232 is integrated.

(Card-Information Complementing Process)

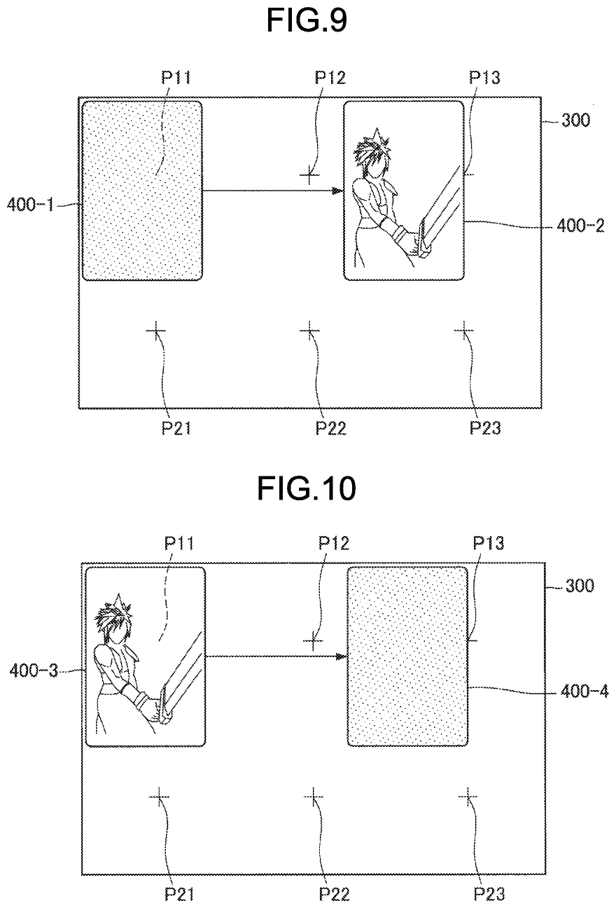

FIG. 9 is a diagram illustrating a first example of the card-information complementing process. Hereinafter, in the following descriptions, wording of “regard” is used, and the wording of “regard” may be replaced with wording of “determine”. With reference to FIG. 9, there is illustrated the pad device 300. The pad device 300 is provided with six antennae (antennae P11 to P13 and P21 to P23). For example, on the basis of function of the application, the output unit 260 of the game console 200 displays a message instructing a user to place a card on an antenna. When seeing the message, the user places a card on the antenna.

In the example illustrated in FIG. 9, the card 400-1 is placed on the antenna P11. In this case, on the basis of detection result of the card 400-1 by an electrostatic capacity sensor, the pad device 300 acquires a position and an orientation of the card 400-1. However, assume that the non-contact communication unit 340 does not read an ID from the card 400-1 for some reason. In FIG. 9, a card (hereinafter may be referred to as “unknown-ID card”) whose ID is not read is indicated by filling the card in gray. History information on a position, an orientation, and an ID (unknown ID) of a card; a time point; etc. is managed by the pad device 300. The processing unit 232 is informed of a position, an orientation, and an ID (unknown ID) of a card.

Assume that a user moves the card 400-1 onto the antenna P13 in accordance with a message displayed by the output unit 260. In FIG. 9, the card 400-1 after the movement is indicated as the card 400-2. In this case, on the basis of detection result of the card 400-2 by an electrostatic capacity sensor, the pad device 300 acquires a position and an orientation of the card 400-2. Assume that the non-contact communication unit 340 reads an ID from the card 400-2. In FIG. 9, a card whose ID has been read is indicated by using a picture on a surface of the card.

As illustrated in the example, when there presents a change in the detection result by the pad device 300 (when state change on surface of pad device 300 occurs), the pad device 300 gives a state-change notification on a surface of the pad device 300 to the processing unit 232. The state-change notification includes a position, an orientation, and an ID of the card after the state change. When receiving the notification related to a state change on a surface of the pad device 300, the processing unit 232 executes a card-information complementing process on the basis of the state-change notification.

The example illustrated in FIG. 9 corresponds to a case where the number of detected cards is one in both cases before a state change (second timing) and after the state change (first timing), an ID of the card 400-1 (second object) detected before the state change is not read, and an ID of the card 400-2 (first object) detected after the state change is read. The processing unit 232 determines that the above-mentioned case corresponds to a card-information complementing process so as to regard the card 400-1 and the card 400-2 as the same.

More specifically, when the number of detected cards is one in both cases before a state change and after the state change, an ID of the card 400-1 detected before the state change is not read, and an ID of the card 400-2 detected after the state change is read; the processing unit 232 employs the ID of the card 400-1 as an identifier of the card 400-1 and further employs the ID of the card 400-1 also as an identifier of the card 400-2. Thus, the processing unit 232 regards the card 400-1 and the card 400-2 as the same. The identifier is identification information of a card used by the application.

Particularly, as illustrated in FIG. 9, when a position of a card is changed between before and after the state change, the processing unit 232 determines that the same card has moved from a position of the card 400-1 to a position of the card 400-2. Note that when an orientation of a card has been changed between before and after the state change, the processing unit 232 may determine that an orientation of the same card has been changed.

FIG. 10 is a diagram illustrating a second example of the card-information complementing process. In the example illustrated in FIG. 10, similarly to the example illustrated in FIG. 9, a card 400-3 is placed on the antenna P11. In this case, on the basis of detection result of the card 400-1 by an electrostatic capacity sensor, the pad device 300 acquires a position and an orientation of the card 400-3. Assume that the non-contact communication unit 340 reads an ID from the card 400-3. The processing unit 232 is informed of a position, an orientation, and an ID of the card.

Assume that a user moves, in response to a message displayed by the output unit 260, the card 400-3 onto the antenna P13. In FIG. 10, the card 400-3 after the movement is indicated as a card 400-4. In this case, on the basis of detection result of the card 400-4 by an electrostatic capacity sensor, the pad device 300 acquires a position and an orientation of the card 400-4. Assume that the non-contact communication unit 340 does not read an ID from the card 400-4.

The example illustrated in FIG. 10 corresponds to a case where the number of detected cards is one in both cases before a state change (first timing) and after the state change (second timing), an ID of the card 400-3 (first object) detected before the state change is read, and an ID of the card 400-4 (second object) detected after the state change is not read. The processing unit 232 determines that the above-mentioned case corresponds to a card-information complementing process so as to regard the card 400-3 and the card 400-4 as the same.

More specifically, when the number of detected cards is one in both cases before a state change and after the state change, an ID of the card 400-3 detected before the state change is read, and an ID of the card 400-4 detected after the state change is not read; the processing unit 232 employs the ID of the card 400-3 as an identifier of the card 400-3 and further employs the ID of the card 400-3 also as an identifier of the card 400-4. Thus, the processing unit 232 regards the card 400-3 and the card 400-4 as the same.

Particularly, as illustrated in FIG. 10, when a position of a card is changed between before and after the state change, the processing unit 232 determines that the same card has moved from a position of the card 400-3 to a position of the card 400-4. Note that when an orientation of a card has been changed between before and after the state change, the processing unit 232 may determine that an orientation of the same card has been changed.

As described above, in the examples illustrated in FIGS. 9 and 10, a case has been supposed in which the number of detected cards is one in both cases before a state change and after the state change. In this case, when an ID of a card is read which is detected in one of before and after the state change, and an ID of a card is not read which is detected in the other of before and after the state change, the processing unit 232 determines that the cards detected before and after the state change are the same to each other. Thus, it is possible to appropriately complement an unknown ID.

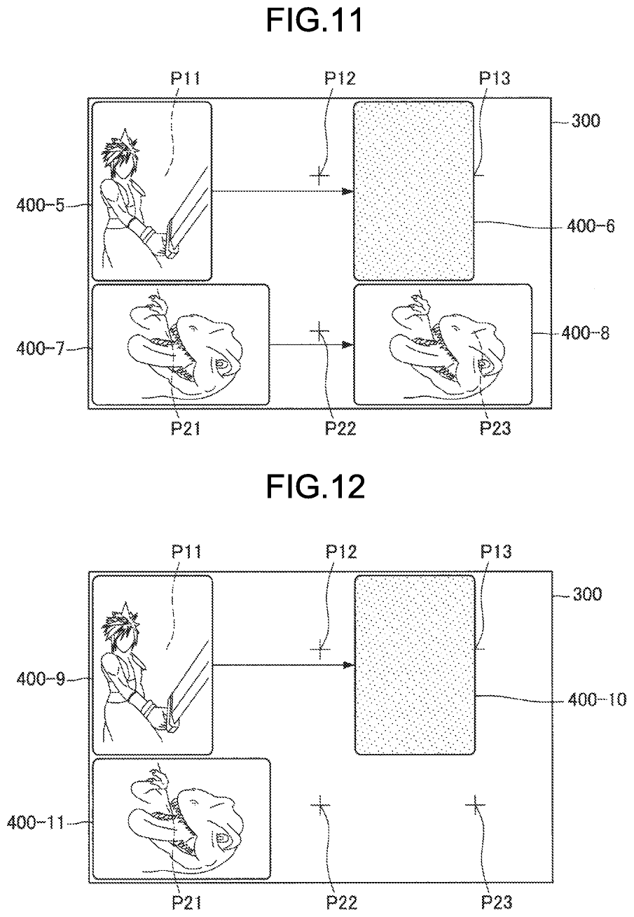

FIG. 11 is a diagram illustrating a third example of the card-information complementing process. In the example illustrated in FIG. 11, a card 400-5 is placed on the antenna P11, and a card 400-7 is placed on the antenna P21. In this case, on the basis of detection result of the card 400-5 and the card 400-7 by electrostatic capacity sensors, positions and orientations of the card 400-5 and the card 400-7 are acquired by the pad device 300. Herein, assume that the non-contact communication unit 340 reads IDs from both of the card 400-5 and the card 400-7. The processing unit 232 is informed of the positions, the orientations, and the IDs of the cards.

Furthermore, assume that in accordance with a message displayed by the output unit 260, a user moves the card 400-5 onto the antenna P13 and further moves the card 400-7 onto the antenna P23. In FIG. 11, the card 400-5 after the movement is illustrated as a card 400-6, and the card 400-7 after the movement is illustrated as a card 400-8. In this case, on the basis of detection result of the card 400-7 and the card 400-8 by electrostatic capacity sensors, positions and orientations of the card 400-7 and the card 400-8 are also acquired by the pad device 300. Assume that the non-contact communication unit 340 is able to read an ID of the card 400-8, on the other hand, an ID of the card 400-6 is not read by the non-contact communication unit 340.

The example illustrated in FIG. 11 corresponds to a case where the number of detected cards is two in both cases before a state change (third timing) and after the state change (fourth timing), an ID of the card 400-7 (third object) detected before the state change and an ID of the card 400-8 (fourth object) detected after the state change are the same to each other, and an ID of the card 400-5 (fifth object) detected before the state change is read and an ID of the card 400-6 (sixth object) detected after the state change is not read. In this case, the processing unit 232 determines that the card 400-5 and the card 400-6 are the same to each other.

Herein, the case is assumed in which the number of cards detected before and after the state change is individually two. However, the number of cards detected before and after the state change may be individually three or more. In this case, when the number of unknown-ID cards detected after a state change is one and the number of cards (hereinafter, may be referred to as “ID confirmed cards”) whose IDs are read before the state change alone is one, similarly, the cards may be determined to be the same.

The same is applied to a case where an ID of the card 400-5 (fifth object) detected before a state change is not read, and an ID of the card 400-6 (sixth object) detect after the state change is read, for example. In other words, a case may be supposed in which the number of cards detected before and after a state change is individually two and an ID of the card 400-7 detected before the state change is the same as an ID of the card 400-8 detected after the state change, and further an ID of the card 400-5 detected before the state change is not read and an ID of the card 400-6 detected after the state change is read. In this case, the processing unit 232 may determine that the card 400-5 and the card 400-6 are the same to each other.

As described above, the number of cards detected before and after a state change may be individually three or more. Even in this case, when the number of unknown-ID cards detected before a state change is one and the number of ID confirmed cards detected after the state change alone is one, the cards may be similarly determined to be the same to each other.

FIG. 12 is a diagram illustrating a fourth example of the card-information complementing process. In the example illustrated in FIG. 12, a card 400-9 is placed on the antenna P11, and a card 400-11 is placed on the antenna P21. In this case, on the basis of detection result of the card 400-9 and the card 400-11 by the electrostatic capacity sensors, the pad device 300 acquires positions and orientations of the card 400-9 and the card 400-11. Assume that the non-contact communication unit 340 reads IDs of both of the card 400-9 and the card 400-11. The processing unit 232 is informed of the positions, the orientations, and the IDs of the cards.

Assume that a user moves, in accordance with a message displayed by the output unit 260, the card 400-9 onto the antenna P13 so as to remove the card 400-11 from an upper surface of the pad device 300. In FIG. 12, the card 400-9 after the movement is indicated as a card 400-10. In this case, on the basis of detection result of the card 400-10 by an electrostatic capacity sensor, the pad device 300 acquires a position and an orientation of the card 400-10. Assume that the non-contact communication unit 340 is not able to read an ID from the card 400-10.

The example illustrated in FIG. 12 corresponds to a case where the number of cards detected before a state change (third timing) is two and the number of cards detected after the state change (fourth timing) is one, IDs of the card 400-9 and the card 400-11 which are detected before the state change are read, and an ID of the card 400-10 detected after the state change is not read. In this case, on the basis of positions (coordinates) of the card 400-9 and the card 400-11 detected before a state change and a position (coordinate) of the card 400-10 detected after the state change, the processing unit 232 searches the card 400-9 and the card 400-11 detected before the state change for a card same as the card 400-10 detected after the state change.

In the example illustrated in FIG. 12, the card 400-9 detected before a state change is closer to the card 400-10 detected after the state change than the card 400-11 detected before the state change. Thus, the processing unit 232 may determine that the card 400-9 detected before a state change closer to the card 400-10 detected after the state change is the same as the card 400-10 detected after the state change.

Note that, as described above, the number of cards detected before a state change may be three or more, and the number of cards detected after the state change may be two or more. Even in this case, when the number of ID confirmed cards is two or more before a state change alone and the number of unknown-ID cards detected after the state change is one or more, similarly, an unknown-ID card detected after the state change and a card detected before the state change which is closer to the unknown-ID card may be determined to be the same.

The same is applied to a case where an ID of a card detected before a state change is not read, and IDs of two cards detected after the state change are read. In other words, a case may be supposed in which the number of cards detected before a state change is one, the number of cards detected after the state change is two, an ID of the card detected before the state change is not read, and IDs of the cards detected after the state change are read.

In this case, on the basis of a position (coordinate) of a card detected before a state change and positions (coordinates) of two cards detected after the state change, the processing unit 232 may search the two cards detected after the state change for a card same as a card detected before the state change. More specifically, the processing unit 232 may determine that a card detected after a state change which is closer to a card detected before the state change is the same as the card detected before the state change.

The number of cards detected after a state change may be three or more, and the number of cards detected before a state change may be two or more. Even in this case, when the number of ID confirmed cards is two or more after a state change alone and the number of unknown-ID cards detected before the state change is one or more, similarly, the unknown-ID card detected before the state change and a card detected after the state change closer to the unknown-ID card may be determined to be the same to each other.

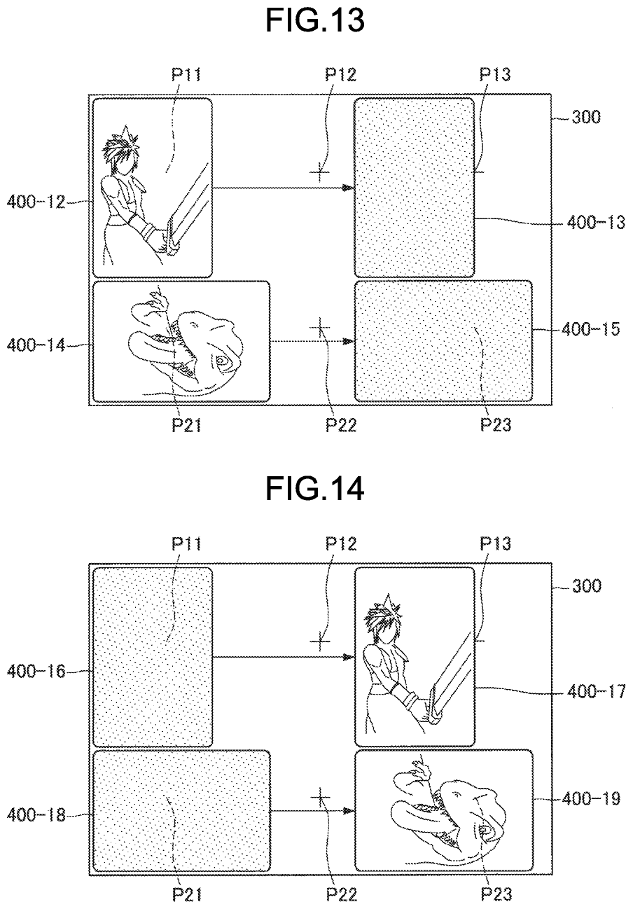

FIG. 13 is a diagram illustrating a fifth example of the card-information complementing process. In the example illustrated in FIG. 13, a card 400-12 is placed on the antenna P11, and a card 400-14 is placed on the antenna P21. In this case, on the basis of detection result of the card 400-12 and the card 400-14 by the electrostatic capacity sensors, the pad device 300 acquires positions and orientations of the card 400-12 and the card 400-14. Assume that the non-contact communication unit 340 reads IDs of both of the card 400-12 and the card 400-14. The processing unit 232 is informed of the positions, the orientations, and the IDs of the cards.

Assume that a user moves, in accordance with a message displayed by the output unit 260, the card 400-12 onto the antenna P13, and further moves the card 400-14 onto the antenna P23. In FIG. 13, the card 400-12 after the movement is indicated as a card 400-13, and the card 400-14 after the movement is indicated as a card 400-15. In this case, on the basis of detection result of the card 400-13 and the card 400-15 by electrostatic capacity sensors, the pad device 300 acquires positions and orientations of the card 400-13 and the card 400-15. Assume that the non-contact communication unit 340 is not able to read IDs from the card 400-13 and the card 400-15.

The example illustrated in FIG. 13 corresponds to a case where the number of cards detected before a state change (third timing) is two and the number of cards detected after the state change (fourth timing) is also two, IDs of the card 400-12 and the card 400-14 which are detected before the state change are read, and IDs of the card 400-13 and the card 400-15 which are detected after the state change are not read.

In this case, the processing unit 232 does not employ, as the IDs of the card 400-13 and the card 400-15 detected after the state change, the IDs of the card 400-12 and the card 400-14 detected before the state change. In other words, the processing unit 232 does not need to complement, on the basis of IDs of the card 400-12 and the card 400-14 detected before the state change, IDs of the card 400-13 and the card 400-15 detected after the state change.

Note that the number of cards detected before and after the state change may be individually three or more. In this case, when the number of ID confirmed cards is two or more before a state change alone and the number of unknown-ID cards detected after the state change is two or more, similarly, IDs of the two or more cards detected before the state change do not need to be employed as IDs of the two or more cards detected after the state change.

FIG. 14 is a diagram illustrating a sixth example of the card-information complementing process. In the example illustrated in FIG. 14, a card 400-16 is placed on the antenna P11, and a card 400-18 is placed on the antenna P21. In this case, on the basis of detection result of the card 400-16 and the card 400-18 by the electrostatic capacity sensors, the pad device 300 acquires positions and orientations of the card 400-16 and the card 400-18. Assume that the non-contact communication unit 340 does not read IDs of both of the card 400-16 and the card 400-18. The processing unit 232 is informed of the positions, the orientations, and the IDs of the cards.

Assume that a user moves, in accordance with a message displayed by the output unit 260, the card 400-16 onto the antenna P13, and further moves the card 400-18 onto the antenna P23. In FIG. 14, the card 400-16 after the movement is indicated as a card 400-17, the card 400-18 after the movement is indicated as a card 400-19. In this case, on the basis of detection result of the card 400-17 and the card 400-19 by the electrostatic capacity sensors, the pad device 300 acquires positions and orientations of the card 400-17 and the card 400-19. Assume that the non-contact communication unit 340 is able to read IDs from the card 400-17 and the card 400-19.

The example illustrated in FIG. 14 corresponds to a case where the number of cards detected before a state change (third timing) is two and the number of cards detected after the state change (fourth timing) is also two, IDs of the card 400-16 and the card 400-18 which are detected before the state change are not read, and IDs of the card 400-16 and the card 400-18 detected after the state change are read.

In this case, the processing unit 232 does not employ, as the IDs of the card 400-16 and the card 400-18 detected before the state change, the IDs of the card 400-17 and the card 400-19 detected after the state change. In other words, the processing unit 232 may determine that the card 400-16 and the card 400-18 detected before the state change are once removed from an upper surface of the pad device 300, and the new card 400-17 and the new card 400-19 are recaptured after the state change by the pad device 300.

Note that, as described above, the number of cards detected before and after the state change may be individually three or more. In this case, when the number of ID confirmed cards is two or more after a state change alone and the number of unknown-ID cards detected before the state change is two or more, similarly, IDs of the two or more cards detected after the state change do not need to be employed as IDs of the two or more cards detected before the state change.

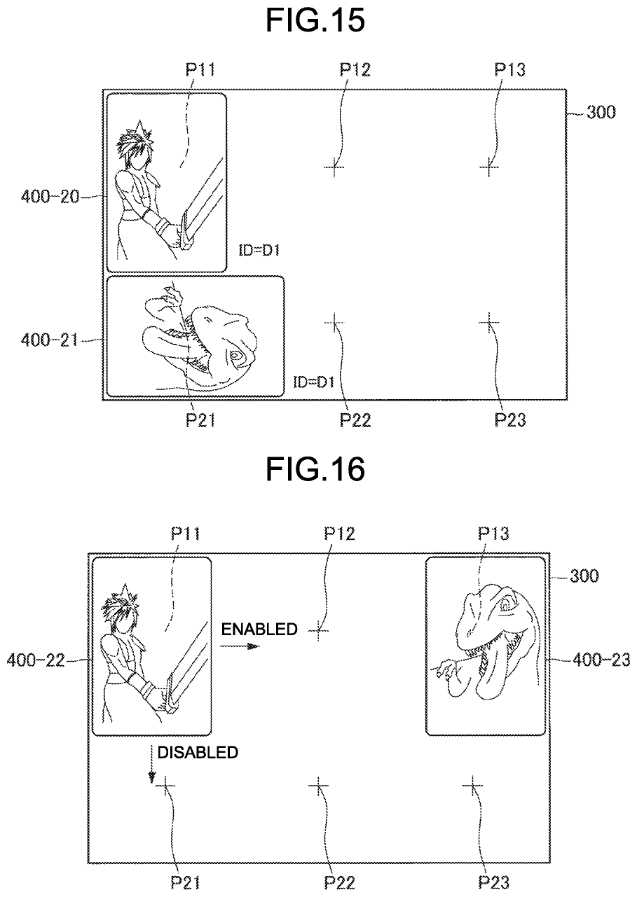

FIG. 15 is a diagram illustrating a seventh example of the card-information complementing process. In the example illustrated in FIG. 15, a card 400-20 is placed on the antenna P11, and a card 400-21 is placed on the antenna P21. In this case, on the basis of detection result of the card 400-20 and the card 400-21 by the electrostatic capacity sensors, the pad device 300 acquires positions and orientations of the card 400-20 and the card 400-21.

Herein, a phenomenon may occur in which the pad device 300 reads the same ID from a plurality of different cards. For example, an antenna does not always read an ID of a card positioned closest to the antenna, and may read an ID of a card positioned second closest to the antenna. In this case, the above-mentioned phenomenon may occur. Assume that the non-contact communication unit 340 reads the same ID (=D1) from the card 400-20 and the card 400-21. The processing unit 232 is informed of the positions, the orientations, and the IDs of the cards.

The example illustrated in FIG. 15 corresponds to a case where an ID read from the card 400-20 (third object) and an ID read from the card 400-21 (fourth object) are the same, which are detected at a timing (third timing). In this case, the processing unit 232 determines that an ID of each of the card 400-20 and the card 400-21 is not read. When the number of cards is three or more whose read IDs are determined to be the same, similarly, the processing unit 232 may determine that an ID of each of the three or more cards is not read.

FIG. 16 is a diagram illustrating an eighth example of the card-information complementing process. In the example illustrated in FIG. 16, a card 400-22 is placed on the antenna P11, and a card 400-23 is placed on the antenna P13. In this case, on the basis of detection result of the card 400-22 and the card 400-23 by the electrostatic capacity sensors, the pad device 300 acquires positions and orientations of the card 400-22 and the card 400-23. Assume that the non-contact communication unit 340 reads IDs of both of the card 400-22 and the card 400-23. The processing unit 232 and application are informed of the positions, the orientations, and the IDs of the cards.

The application specifies the next movement of a card on the basis of a reported position and a reported ID of the card. Assume that, in the example illustrated in FIG. 16, the application expects that a character on the card 400-22 attacks a character on the card 400-23 so as to specify, as a receivable movement, a movement of the card 400-22 in a direction (in FIG. 16, in right direction) toward the card 400-23.

In this case, in a state where the application specifies a receivable movement of the card 400-22, when detecting a movement (for example, downward movement, etc.) of the card 400-22 that is different from the receivable movement, the processing unit 232 may neglect the detected movement of the card 400-22 (may be disabled). On the other hand, under a similar state, when detecting a movement (for example, rightward movement, etc.) of the card 400-22 which coincides with the receivable movement, the processing unit 232 may enable the detected movement of the card 400-22. Thus, detection accuracy of a movement specified by the application is improved.

As described above, when the card-information complementing process is executed, the processing unit 232 informs the application of an identifier of a card and a position of the card. The application executes a process according to the identifier and the position of the card reported from the processing unit 232. For example, when the application is game application, the application advances the game on the basis of the identifier and the position of the card reported from the processing unit 232.

(Operation of Information Processing System)

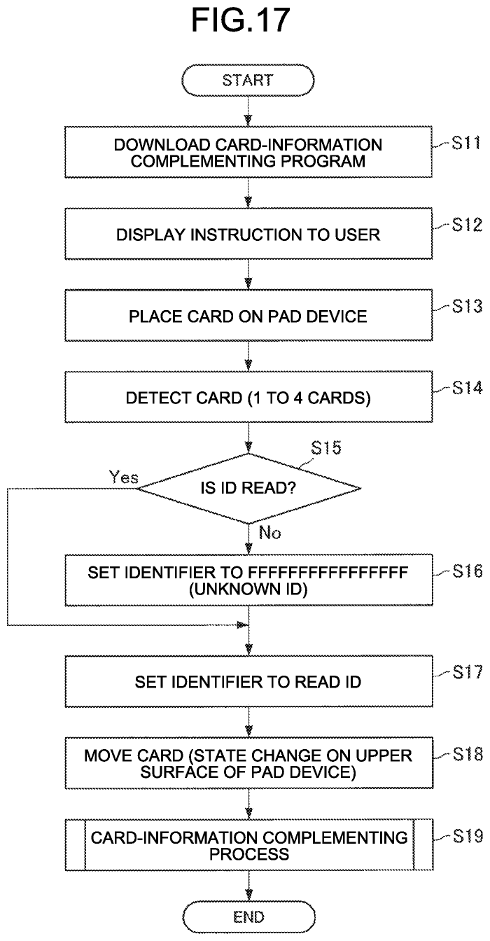

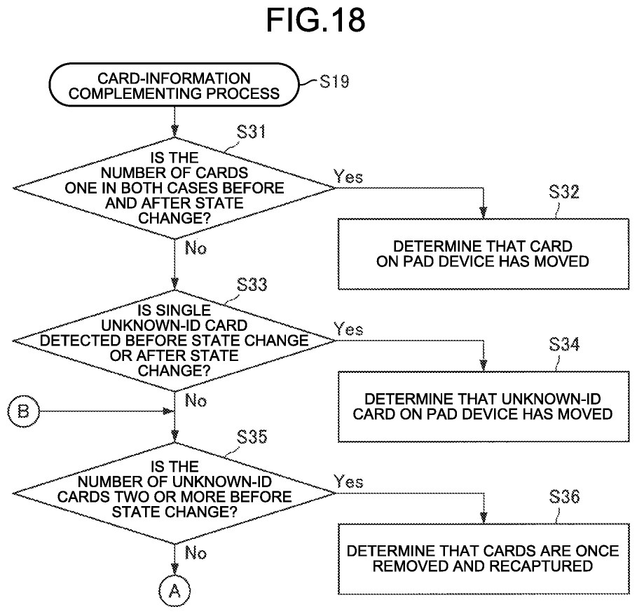

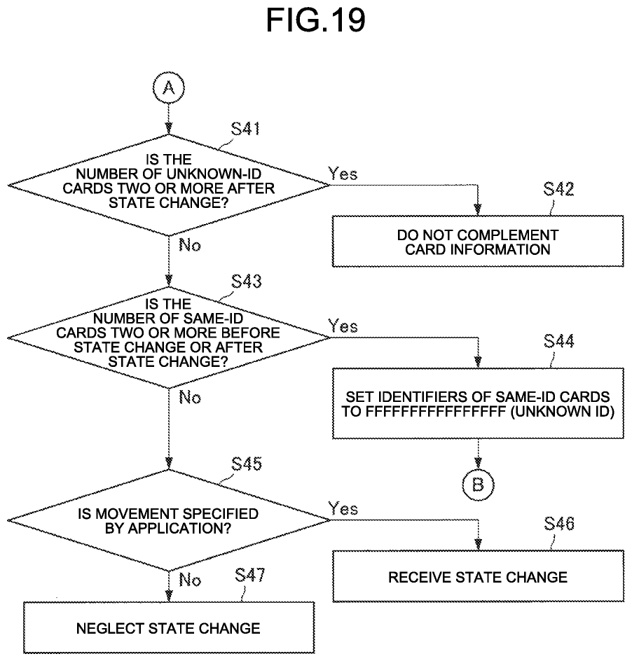

Subsequently, operation of the information processing system according to the first embodiment of the present disclosure will be specifically explained with reference to FIGS. 17 to 19. FIG. 17 is a flowchart illustrating an example of operation of the information processing system according to the first embodiment of the present disclosure. Each of FIGS. 18 and 19 is a flowchart illustrating details of the card-information complementing process according to the first embodiment of the present disclosure. As illustrated in FIG. 17, the acquisition unit 231 downloads a card-information complementing program from the server device 500 (Step S11). When a processor executes the card-information complementing program, the card-information complementing process by the processing unit 232 may be realized.

Subsequently, on the basis of function of the application, the output unit 260 of the game console 200 displays a message instructing a user to place a card on an antenna (Step S12). When seeing message, the user places a card on the pad device 300. Subsequently, the pad device 300 detects the card placed on the pad device 300 (Step S14). Herein, as described above, a case is supposed in which the pad device 300 may simultaneously detect a maximum of four cards.

The application and the processing unit 232 are informed of a position and an orientation of the card which are detected by the pad device 300 and an ID that is read by the pad device 300. When determining, on the basis of the position, the orientation, and the ID of the card that are reported from the pad device 300, that there presents a card whose ID is not read (Step S15: No); the application sets an identifier of the card to “unknown ID” (Step S16), and shifts the operation to Step S17.

When determining, on the basis of the position, the orientation, and the ID of the card that are reported from the pad device 300, that there presents no card whose ID is not read (Step S15: Yes); the application shifts the operation to Step S17. The application sets an identifier of the card whose ID is read to the read ID (Step S17). Subsequently, when the user moves the card (in other words, changes state on upper surface of pad device 300) (Step S18), a state-change notification is sent from the pad device 300 to the processing unit 232. On the basis of the state-change notification, the processing unit 232 executes a card-information complementing process (Step S19).

Details of the card-information complementing process will be explained with reference to FIGS. 18 and 19. When the number of cards on the pad device 300 is one in both cases before and after a state change on the pad device 300 (Step S31: Yes), the processing unit 232 determines that the card on the pad device 300 has moved (Step S32). For example, the processing unit 232 regards, as the same to each other, an ID confirmed card detected in one of before and after a state change and an unknown-ID card detected in the other, so as to determine that the card on the pad device 300 has moved.

When two or more cards are detected on the pad device 300 before a state change or after the state change (Step S31: No), the processing unit 232 shifts the processing to Step S33. When a single unknown-ID card is detected on the pad device 300 before a state change or after the state change (Step S33: Yes), the processing unit 232 determines that an unknown-ID card on the pad device 300 has moved (Step S34). For example, the processing unit 232 regards, as the same to each other, an ID confirmed card detected in one of before and after a state change and an unknown-ID card detected in the other, so as to determine that a card on the pad device 300 has moved.

When detecting two or more unknown-ID cards on the pad device 300 before a state change (Step S35: Yes), the processing unit 232 determines that the two or more unknown-ID cards detected before the state change are once removed from an upper surface of the pad device 300, and new two or more cards are recaptured after the state change by the pad device 300 (Step S36). As described above, on the basis of a position (coordinate) of an unknown-ID card, a card same as the unknown-ID card may be searched for.

When two or more unknown-ID cards are not detected before a state change on the upper surface of the pad device 300 (Step S35: No), the processing unit 232 shifts the processing to Step S41. When two or more unknown-ID cards are detected after a state change on the upper surface of the pad device 300 (Step S41: Yes), the processing unit 232 does not complement card information (Step S42). For example, the processing unit 232 does not employ IDs of the two or more cards detected before the state change as identifiers of the two or more unknown-ID cards detected after the state change, so as not to complement card information. Note that, as described above, on the basis of a position (coordinate) of an unknown-ID card, a card same as the unknown-ID card may be searched for.

When two or more unknown-ID cards are not detected after a state change on the pad device 300 (Step S41: No), the processing unit 232 shifts the processing to Step S43. When detecting two or more cards, from which the same ID is read, before a state change or after the state change on the upper surface of the pad device 300 (Step S43: Yes), the processing unit 232 sets, to “unknown IDs”, identifiers of the cards from which the same ID is read (Step S44), and returns the processing to Step S35.

When not detecting two or more cards, from which the same ID is read, before a state change or after the state change on the upper surface of the pad device 300 (Step S43: No), the processing unit 232 shifts the processing to Step S45. When a movement of a card detected by the pad device 300 coincides with a movement specified by the application (Step S45: Yes), the processing unit 232 receives a state change (Step S46). For example, on the basis of an ID read from a card and a position (coordinate) of the card after a state change, the processing unit 232 updates a coordinate corresponding to an identifier of the card so as to receive the state change.

On the other hand, when a movement of a card detected by the pad device 300 does not coincide with a movement specified by the application (Step S45: No), the processing unit 232 neglects the state change (Step S47).

When the card-information complementing process illustrated in FIGS. 18 and 19 is executed, the processing unit 232 informs the application of an identifier of a card and a position of the card. The application executes a process according to the identifier and the position of the card which are reported from the processing unit 232. For example, when the application is game application, the application advances the game on the basis of the identifier and the position of the card reported from the processing unit 232.

As described above, the first embodiment according to the present disclosure has been explained.

### 2. Second Embodiment

Next, a second embodiment according to the present disclosure will be explained. In the first embodiment according to the present disclosure, the case has been explained in which the single pad device 300 is used. In the second embodiment according to the present disclosure, a case will be explained in which detection regions of the plurality of pad devices 300 logically form a single coordinate space. Hereinafter, in the second embodiment according to the present disclosure, configurations different from those according to the first embodiment of the present disclosure will be mainly described, and the description of configurations common to those according to the first embodiment of the present disclosure is appropriately omitted. A card-information complementing process will be mainly explained.

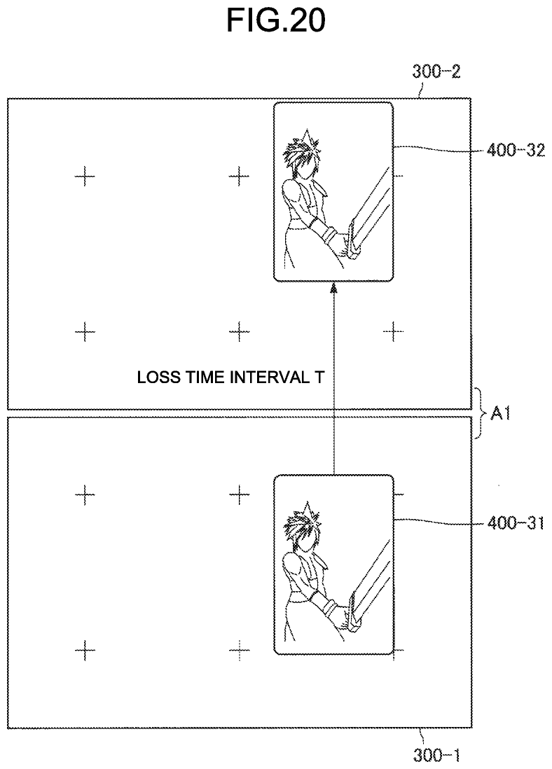

FIG. 20 is a diagram illustrating a ninth example of the card-information complementing process. With reference to FIG. 20, a pad device 300-1 (first pad device) and a pad device 300-2 (second pad device) are illustrated. An upper surface (first detection region) of the pad device 300-1 and an upper surface (second detection region) of the pad device 300-2 logically form a single coordinate space. A region having a predetermined width in each of the pad device 300-1 and the pad device 300-2, which faces the corresponding other device, is indicated as a boundary region A1. When a card is placed on the boundary region A1, the card is detected by both of the pad device 300-1 and the pad device 300-2, and thus capturing of the card is difficult.

In the example illustrated in FIG. 20, a card 400-31 (third object) is placed on the pad device 300-1. In this case, on the basis of detection result of the card 400-31 by the electrostatic capacity sensor, the pad device 300-1 acquires a position and an orientation of the card 400-31. Assume that the non-contact communication unit 340 reads an ID from the card 400-31. The processing unit 232 is informed of a position, an orientation, and an ID of the card.

Assume that a user moves, in accordance with a message displayed by the output unit 260, the card 400-31 onto the pad device 300-2. In FIG. 20, the card 400-31 after the movement is indicated as a card 400-32. In this case, on the basis of detection result of the card 400-32 by an electrostatic capacity sensor, the pad device 300-2 acquires a position and an orientation of the card 400-32. Assume that the non-contact communication unit 340 reads an ID from the card 400-32.

Herein, a case is mainly supposed in which IDs are read from both of the card 400-31 and the card 400-32. However, an ID does not need to be read from one of the card 400-31 and the card 400-32. Even in this case, as already described in the first embodiment according to the present disclosure, the card 400-31 and the card 400-32 may be determined to be the same.

As described above, due to presence of the boundary region A1, there may present a time difference from a time point (hereinafter, may be referred to as “loss time point”) at which the card 400-31 goes out of detection in the pad device 300-1 until a time point (hereinafter, may be referred to as “detection time point”) at which the card 400-32 is detected by the pad device 300-2. Thus, it is preferable that when the time difference is within a predetermined time interval, the card 400-31 is determined not to be lost from the pad device 300-1.

Specifically, as illustrated in FIG. 20, an elapsed time interval from a time point at which the card 400-31 goes out of detection by the pad device 300-1 (from time point at which card 400-31 is lost from upper surface of pad device 300-1) is defined as a loss time interval T. It is preferable that when the loss time interval T from a time point at which the card 400-31 goes out of detection by the pad device 300-1 until a time point at which the card 400-32 is detected by the pad device 300-2 is within a predetermined time interval, the processing unit 232 determines that the card 400-31 is on the pad device 300-1.

On the other hand, it is preferable that in a case where the loss time interval T exceeds the predetermined time interval even when the loss time interval T is from a time point at which the card 400-31 goes out of detection by the pad device 300-1 until a time point at which the card 400-32 is detected by the pad device 300-2, the processing unit 232 determines that the card 400-31 has not been present on the pad device 300-1 since the time point at which the card 400-31 actually went out of detection by the pad device 300-1.

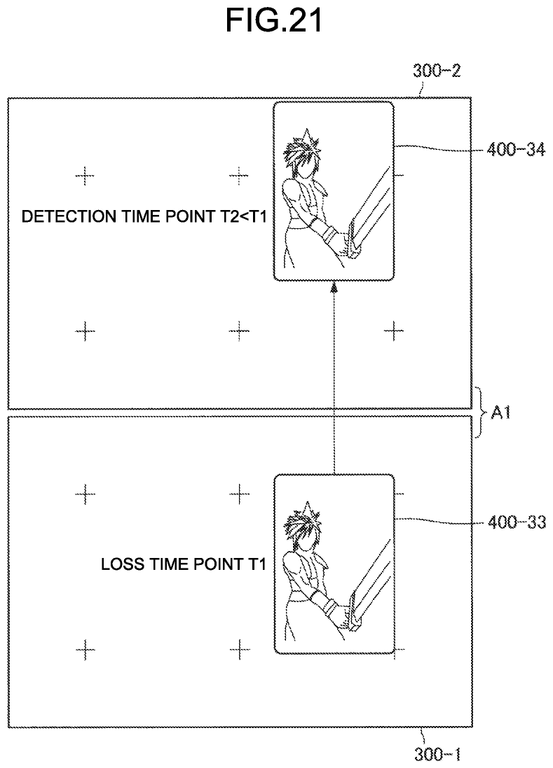

FIG. 21 is a diagram illustrating a tenth example of the card-information complementing process. The pad device 300-1 and the pad device 300-2 are illustrated in FIG. 21. An upper surface of the pad device 300-1 and an upper surface of the pad device 300-2 logically form a single coordinate space. Similarly to the example illustrated in FIG. 20, there presents the boundary region A1.

In the example illustrated in FIG. 21, a card 400-33 (third object) is placed on the pad device 300-1. In this case, on the basis of detection result of the card 400-33 by the electrostatic capacity sensor, the pad device 300-1 acquires a position and an orientation of the card 400-33. Assume that the non-contact communication unit 340 reads an ID from the card 400-33. The processing unit 232 is informed of a position, an orientation, and an ID of the processing unit 232.

Assume that a user moves, in accordance with a message displayed by the output unit 260, the card 400-33 onto the pad device 300-2. In FIG. 21, the card 400-33 after the movement is indicated as a card 400-34. In this case, on the basis of detection result of the card 400-34 by an electrostatic capacity sensor, the pad device 300-2 acquires a position and an orientation of the card 400-34. Assume that the non-contact communication unit 340 reads an ID from the card 400-32.

Herein, similarly to the example illustrated in FIG. 20, a case is mainly supposed in which IDs are read from both of the card 400-33 and the card 400-34. However, an ID does not need to be read from one of the card 400-33 and the card 400-34. Even in this case, as already described in the first embodiment according to the present disclosure, the card 400-33 and the card 400-34 may be determined to be the same.

Contrary to the example illustrated in FIG. 20, there may present a case where a time point (detection time point) at which the card 400-34 is detected by the pad device 300-2 comes before a time point (loss time point) at which the card 400-33 goes out of detection of the pad device 300-1. Thus, it is preferable that when a detection time point of the pad device 300-2 comes before a loss time point of the pad device 300-1, detection result of the card 400-33 by the pad device 300-1 from the loss time point until the detection time point is not employed.

Specifically, as illustrated in FIG. 21, a loss time point of the card 400-33 on the pad device 300-1 is defined as a loss time point T1, and a detection time point of the card 400-34 on the pad device 300-2 is defined as a detection time point T2. When the detection time point T2 comes before the loss time point T1, it is preferable that the processing unit 232 does not employ a position of the card 400-33 which is detected on the pad device 300-1 after the detection time point T2.

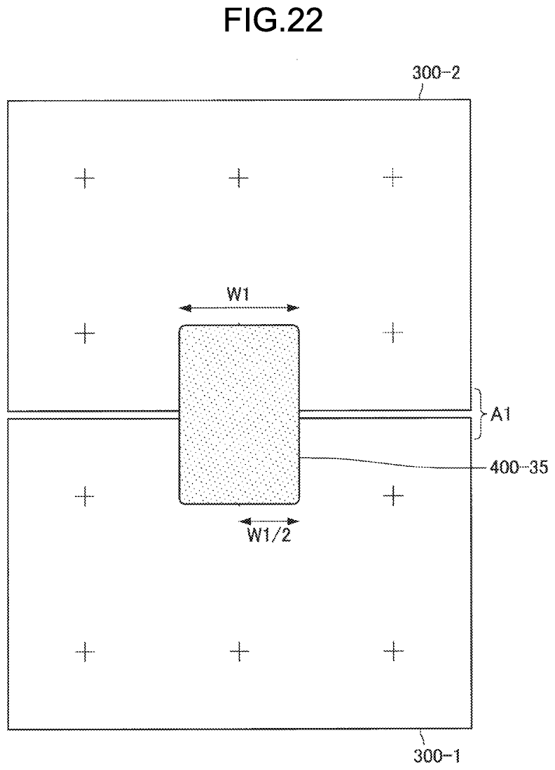

FIG. 22 is a diagram illustrating an eleventh example of the card-information complementing process. The pad device 300-1 and the pad device 300-2 are illustrated in FIG. 22. An upper surface of the pad device 300-1 and an upper surface of the pad device 300-2 logically form a single coordinate space. Similarly to the example illustrated in FIG. 20, there presents the boundary region A1.

In the example illustrated in FIG. 22, a card 400-35 (third object) is placed on the boundary region A1 between the pad device 300-1 and the pad device 300-2. In this case, on the basis of detection result of the card 400-35 by the electrostatic capacity sensor, the pad device 300-1 and the pad device 300-2 acquire a position and an orientation of the card 400-35.

In FIG. 22, the card 400-35 is arranged such that a long-side direction of the card 400-35 is along a short-side direction (Y-direction) of each of the pad device 300-1 and the pad device 300-2 (hereinafter, such arrangement of card may be referred to as “vertical arrangement”). Furthermore, in FIG. 22, a length of a short side of the card 400-35 is indicated as “W1” (W1/2 is half of length of short side). Herein, assume that the non-contact communication unit 340 does not read an ID of the card 400-35. The processing unit 232 is informed of a position, an orientation, and an ID of the card.

In the boundary region A1, the single card 400-35 is not always detected. In other words, a case is supposed in which one or more cards (one or plurality of cards) including the card 400-35 are detected, as a card group, in the boundary region A1. However, when an ID is not read from each of the cards, whether or not the number of cards constituting the card group is one is not able to be determined from an ID. Thus, on the basis of a length in a predetermined direction of a card group detected in the boundary region A1, the processing unit 232 determines whether or not the number of cards constituting the card group is one.

Specifically, when a card group (one or plurality of cards) including the card 400-35 (third object) is detected in the boundary region A1, the processing unit 232 determines whether or not the number of cards constituting the card group is plural on the basis of whether or not a length of the card group in a predetermined direction (as illustrated in FIG. 22, in case of vertical arrangement, length of card group in long-side direction of pad device) is larger than a predetermined length (as illustrated in FIG. 22, in case of vertical arrangement, length W1 of short side of card) according to an orientation of the card 400-35.

The processing unit 232 may determine that the number of cards constituting a card group is plural when a length of the card group in a predetermined direction (in case of vertical arrangement, length of card group in long-side direction of pad device) is larger than a predetermined length (in case of vertical arrangement, length W1 of short side of card) according to an orientation of the card 400-35. On the other hand, the processing unit 232 may determine that the number of cards constituting a card group is one when a length of the card group in a predetermined direction (in case of vertical arrangement, length of card group in long-side direction of pad device) is equal to or less than a predetermined length (in case of vertical arrangement, length W1 of short side of card) according to an orientation of the card 400-35.

In the example illustrated in FIG. 22, a length of a card group in a predetermined direction (in case of vertical arrangement, length of card group in long-side direction of pad device) is substantially the same as a predetermined length (in case of vertical arrangement, length W1 of short side of card) according to an orientation of the card 400-35, and thus the processing unit 232 determines that the number of cards constituting the card group is one. In the above description, the case has been mainly explained in which the length W1 of a short side of a card is compared with a length of a card group in a long-side direction of a pad device. However, instead of the length W1 of the short side of the card, a half (½×W) of the length W1 of the short side of the card may be compared with a length of the card group in the long-side direction of the pad device.

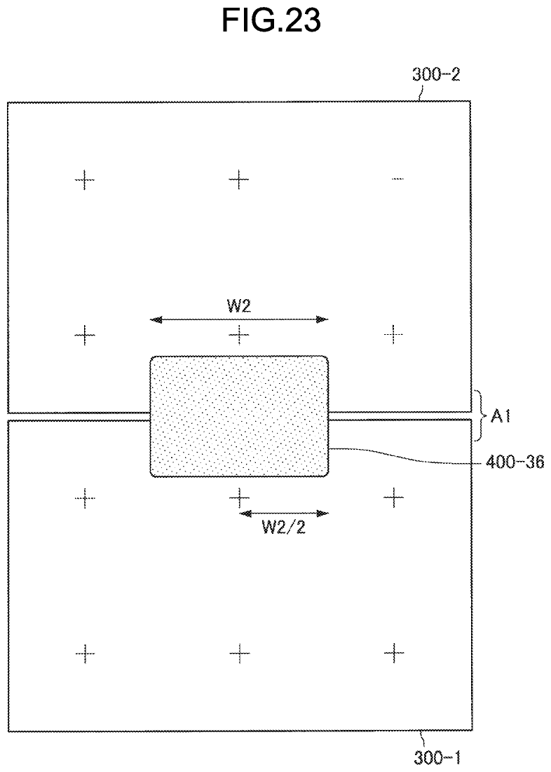

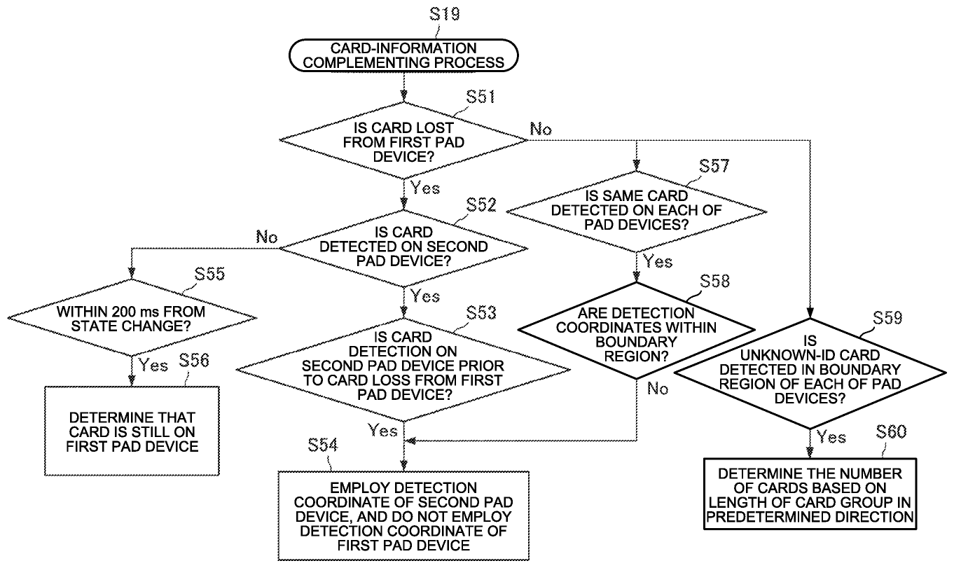

FIG. 23 is a diagram illustrating a twelfth example of the card-information complementing process. The pad device 300-1 and the pad device 300-2 are illustrated in FIG. 23. An upper surface of the pad device 300-1 and an upper surface of the pad device 300-2 logically form a single coordinate space. Similarly to the example illustrated in FIG. 20, there presents the boundary region A1.

In the example illustrated in FIG. 23, a card 400-36 (third object) is placed on the boundary region A1 between the pad device 300-1 and the pad device 300-2. In this case, on the basis of detection result of the card 400-35 by the electrostatic capacity sensor, the pad device 300-1 and the pad device 300-2 acquire a position and an orientation of the card 400-36.

In FIG. 23, the card 400-36 is arranged such that a long-side direction of the card 400-36 is along a long-side direction (X-direction) of each of the pad device 300-1 and the pad device 300-2 (hereinafter, such arrangement of card may be referred to as “horizontal arrangement”). Furthermore, in FIG. 23, a length of a long side of the card 400-36 is indicated as “W2” (W2/2 is half of length of short side). Herein, assume that the non-contact communication unit 340 does not read an ID of the card 400-36. The processing unit 232 is informed of a position, an orientation, and an ID of the card.

When detecting a card group (one or plurality of cards) including the card 400-36 (third object) in the boundary region A1, the processing unit 232 may determine that the number of cards constituting the card group is plural in accordance with whether or not a length (as illustrated in FIG. 23, in case of horizontal arrangement, length of card group in long-side direction of pad device) of the card group in a predetermined direction is larger than a predetermined length (as illustrated in FIG. 23, in case of horizontal arrangement, length W2 of long side of card) according to an orientation of the card 400-36.

The processing unit 232 may determine that the number of cards constituting a card group is plural when a length (in case of horizontal arrangement, length of card group in long-side direction of pad device) of the card group in a predetermined direction is larger than a predetermined length (in case of horizontal arrangement, length W2 of long side of card) according to an orientation of the card the card 400-36. On the other hand, the processing unit 232 may determine that the number of cards constituting a card group is one when a length (in case of horizontal arrangement, length of card group in long-side direction of pad device) of the card group in a predetermined direction is equal to or less than a predetermined length (in case of horizontal arrangement, length W2 of long side of card) according to an orientation of the card 400-36.

In the example illustrated in FIG. 23, a length (in case of horizontal arrangement, length of card group in long-side direction of pad device) of a card group in a predetermined direction is substantially the same as a predetermined length (in case of horizontal arrangement, length W2 of long side of card) according to an orientation of the card 400-36, and thus the processing unit 232 determines that the number of cards constituting the card group is one. In the above description, the case has been mainly explained in which the length W2 of a long side of a card is compared with a length of a card group in a long-side direction of a pad device. However, instead of the length W2 of the long side of the card, a half (W2/2) of the length W2 of the long side of the card may be compared with a length of the card group in the long-side direction of the pad device.

(Operation of Information Processing System)

Next, operation of the information processing system according to the second embodiment of the present disclosure will be explained. Compared with the operation (see FIG. 17) of the information processing system according to the first embodiment of the present disclosure, operation of the information processing system according to the second embodiment of the present disclosure differs in a card-information complementing process of Step S19. Therefore, the card-information complementing process of Step S19 according to the second embodiment of the present disclosure will be specifically explained with reference to FIG. 24. FIG. 24 is a flowchart illustrating details of the card-information complementing process according to the second embodiment of the present disclosure.

As illustrated in FIG. 24, when a card is lost from the first pad device (pad device 300-1) (Step S51: Yes), the processing unit 232 shifts the processing to Step S52. In a state where a card is not detected on the second pad device (pad device 300-2) (Step S52: No), when a predetermined time interval (for example, 200 ms) has not elapsed since a state on an upper surface of the pad device 300 is changed (Step S55: Yes), the processing unit 232 determines that the card is still on the first pad device (pad device 300-1) (Step S56).

When a card is detected on the second pad device (pad device 300-2) (Step S52: Yes), the processing unit 232 shifts the processing to Step S53. When card detection on the second pad device (pad device 300-2) is prior to card lost from the first pad device (pad device 300-1) (Step S53: Yes), the processing unit 232 employs a detection coordinate of the second pad device (pad device 300-2) and does not employ a detection coordinate of the first pad device (pad device 300-1) (Step S54). Even in a case where the same card is detected on each of the pad devices (Step S57: Yes), when detection coordinates are out of the boundary region (Step S58: No), the processing unit 232 executes Step S54.

On the other hand, when a card is not lost from the first pad device (pad device 300-1) (Step S51: No), the processing unit 232 shifts the processing to Step S59. When an unknown-ID card is detected in a boundary region of each of the pad devices (Step S59: Yes), the processing unit 232 determines the number of cards constituting a card group on the basis of a length of the card group including the unknown-ID card in a predetermined direction (Step S60).

As described above, the second embodiment according to the present disclosure has been explained.

### 3. Third Embodiment

Next, a third embodiment according to the present disclosure will be explained. In the first and the second embodiments according to the present disclosure, the case has been mainly explained in which the card 400 is placed on the pad device 300. In the third embodiment according to the present disclosure, a case will be explained in which input is performed on the pad device 300 by an operation body (object whose identification information is not able to be read). An example of the operation body is mainly explained to be a finger; however, the operation body is not limited to a finger, and may be a pen or the like. Hereinafter, in the third embodiment according to the present disclosure, configurations different from those according to the first embodiment of the present disclosure will be mainly described, and the description of configurations common to those according to the first embodiment of the present disclosure is appropriately omitted. A card-information complementing process will be mainly explained.

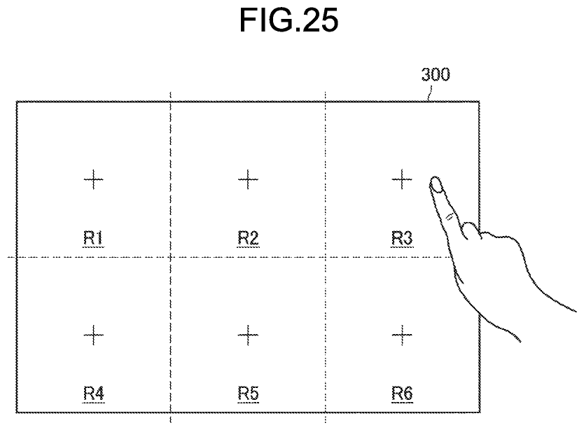

FIG. 25 is a diagram illustrating a thirteenth example of the card-information complementing process. The pad device 300 is illustrated in FIG. 25. An upper surface (detection region) of the pad device 300 is configured to include a plurality of divided regions. Herein, a case is supposed in which an upper surface (detection region) of the pad device 300 includes a total of six divided regions R1 to R6 constituted of three columns in a long-side direction (X-direction) and two rows in a short-side direction (Y-direction) in accordance with arrangement of six antennae and coils. However, the number of divided regions and/or arrangement of the divided regions are not limited thereto.

On the basis of whether or not at least one finger is detected, the processing unit 232 determines whether or not a finger is detected for each of the divided region R1 to R6. In the example illustrated in FIG. 25, a single finger is detected in the divided region R3, and thus the processing unit 232 determines that a finger is detected in the divided region R3. Even when two or more fingers are detected in the divided region R3, the detection result is the same, and the processing unit 232 determines that a finger is detected in the divided region R3. Thus, a divided region selected by a user is able to be determined at a lower processing cost. On the other hand, the processing unit 232 determines that a finger is not detected in the divided regions R1, R2, and R4 to R6.

When the card-information complementing process illustrated in FIG. 25 is executed, the processing unit 232 informs the application of information indicating presence of a divided region that is in contact with a finger. The application executes a process according to the information indicating the divided region reported from the processing unit 232. For example, when the application is game application, the application advances the game on the basis of the information indicating the divided region reported from the processing unit 232.

(Operation of Information Processing System)

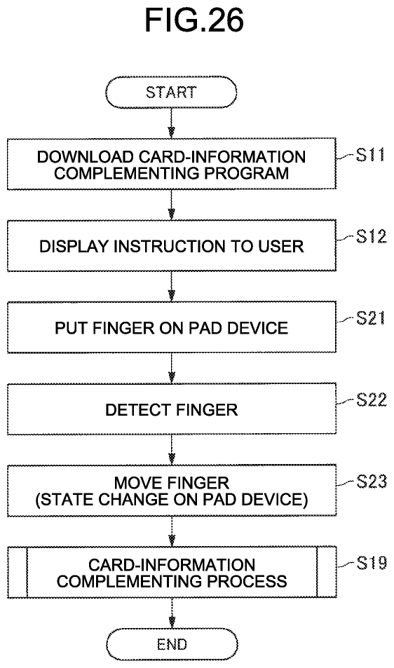

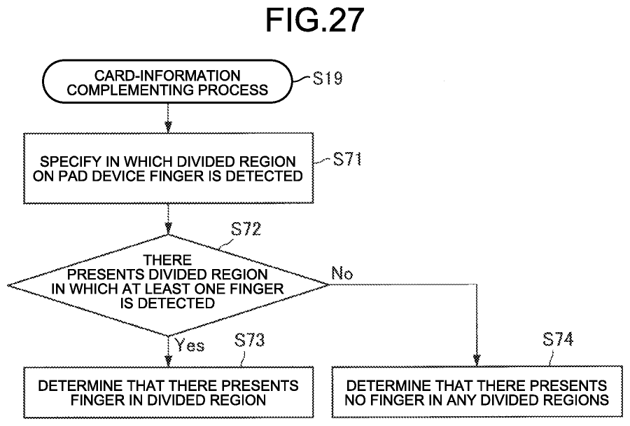

Next, operation of the information processing system according to the third embodiment of the present disclosure will be specifically explained with reference to FIGS. 26 and 27. FIG. 26 is a flowchart illustrating an example of operation of an information processing system according to the third embodiment of the present disclosure. FIG. 27 is a flowchart illustrating details of the card-information complementing process according to the third embodiment of the present disclosure. As illustrated in FIG. 26, similarly to the first embodiment of the present disclosure, the acquisition unit 231 executes Steps S11 and S12.

A user having seen the message puts his/her finger on the pad device 300. Subsequently, the pad device 300 detects the finger put on the pad device 300 (Step S22). The application and the processing unit 232 are informed of a position of the at least one finger detected by the pad device 300. Next, when the user moves his/her finger (in other words, changes state on upper surface of pad device 300) (Step S23), the pad device 300 notifies the processing unit 232 of a state-change notification. On the basis of the state-change notification, the processing unit 232 executes a card-information complementing process (Step S19).

Details of the card-information complementing process will be specifically explained with reference to FIG. 27. The processing unit 232 specifies in which divided region on an upper surface of the pad device 300 a finger is detected (Step S71). When there presents a divided region in which at least one finger is detected (Step S72: Yes), the processing unit 232 determines that there presents a finger in the divided region (Step S73). On the other hand, when there presents no divided region in which at least one finger is detected (Step S72: No), the processing unit 232 determines that there presents no finger in any divided regions (Step S74).

When the card-information complementing process illustrated in FIG. 27 is executed, the processing unit 232 informs the application of information indicating the divided region in which the finger presents. The application executes a process according to the information indicating the divided region reported from the processing unit 232. For example, when the application is game application, the application advances the game on the basis of the information indicating the divided region reported from the processing unit 232.

As described above, the third embodiment according to the present disclosure has been explained.

### 4. Conclusion

As described above, according to the first embodiment of the present disclosure, it is possible to realize a technology that is capable of appropriately complementing unknown identification information. According to the second embodiment of the present disclosure, even when detection regions of a plurality of pad devices logically form a single coordinate space, it is possible to more appropriately control detection of an object between the plurality of pad devices. According to the third embodiment of the present disclosure, it is possible to determine a divided region selected by a user at a lower processing cost.

While preferable embodiments of the present disclosure have been described above in detail with reference to the attached drawings, the technical scope of the present disclosure is not limited thereto. It is obvious that those skilled in the technical field of the present disclosure could have conceived of various changes or modifications within the scope of the technical ideas described in the claims, and it is understood that those changes or modifications also reasonably belong to the technical scope of the present disclosure.

In addition, it is also possible to create a computer program that allows hardware such as CPU, ROM, and RAM built in the above-mentioned game console 200, the pad device 300, or the card 400 to exert functions equivalent to those of the game console 200, the pad device 300, or the card 400. Furthermore, a computer-readable storage medium that stores therein the computer program can also be provided.

Furthermore, the effects described in the present specification are merely explanations or exemplifications, and are not limiting. In other words, the techniques according to the present disclosure may exert other effects that are obvious to those skilled in the art from the descriptions of the present specification, along with the above-described effects or instead of the above-described effects.

The present technology may have the following configurations.

(1) An information processing apparatus comprising:

a processing unit configured to:
when identification information of a first object that is detected at a first timing is read and further when identification information of a second object that is detected at a second timing different from the first timing is not read, determine that the first object and the second object are a same to each other.
   (2) The information processing apparatus according to (1), wherein

the second timing is a timing at which an object state is changed after the first timing.

(3) The information processing apparatus according to (1), wherein

the first timing is a timing at which an object state is changed after the second timing.

(4) The information processing apparatus according to any one of (1) to (3), wherein

the processing unit is further configured to:

employ the identification information of the first object as the identification information of the second object to determine that the first object and the second object are a same to each other.

(5) The information processing apparatus according to any one of (1) to (4), wherein

the processing unit is further configured to:

when identification information of a third object that is detected at a third timing and identification information of a fourth object that is detected at a fourth timing are a same to each other, determine that a fifth object that is detected at the third timing and a sixth object that is detected at the fourth timing are a same to each other.

(6) The information processing apparatus according to any one of (1) to (4), wherein

the processing unit is further configured to:

when identification information of a plurality of objects that is detected at a third timing is read and identification information of at least one object that is detected at a fourth timing is not read, based on coordinates of the plurality of objects and a coordinate of the at least one object, search the plurality of objects for an object that is a same as the at least one object.

(7) The information processing apparatus according to any one of (1) to (4), wherein

the processing unit is further configured to:

when identification information of a plurality of third objects that is detected at a third timing is not read and identification information of a plurality of fourth objects that is detected at a fourth timing is read, not employ the identification information of the plurality of fourth objects as the identification information of the plurality of third objects.

(8) The information processing apparatus according to any one of (1) to (4), wherein

the processing unit is further configured to:

when identification information of a plurality of third objects that is detected at a third timing is read and identification information of a plurality of fourth objects that is detected at a fourth timing is not read, not employ the identification information of the plurality of third objects as the identification information of the plurality of fourth objects.

(9) The information processing apparatus according to any one of (1) to (4), wherein

the processing unit is further configured to:

when pieces of identification information read from a third object and a fourth object that are detected at a third timing are a same to each other, determine that the respective pieces of identification information of the third object and the fourth object are not read.

(10) The information processing apparatus according to any one of (1) to (4), wherein

a first detection region and a second detection region logically form a single coordinate space, and

the processing unit is further configured to:
when a time interval from a timing at which a third object goes out of detection in the first detection region until a timing at which a fourth object is detected in the second detection region is within a predetermined time interval, determine that the third object presents in the first detection region.
   (11) The information processing apparatus according to any one of (1) to (4), wherein

a first detection region and a second detection region logically form a single coordinate space, and

the processing unit is further configured to:
when a fourth object is detected in the second detection region before a third object goes out of detection in the first detection region, not employ a position of the third object which is detected in the first detection region after the fourth object is detected in the second detection region. (12) The information processing apparatus according to any one of (1) to (4), wherein

a first detection region and a second detection region logically form a single coordinate space, and

the processing unit is further configured to:
when one or more objects including a third object are detected in a boundary region of the first detection region and the second detection region, determine whether or not a number of the one or more objects is plural based on whether or not lengths of the one or more objects in a predetermined direction are larger than a predetermined length according to an orientation of the third object.
   (13) The information processing apparatus according to any one of (1) to (12), wherein

the processing unit is further configured to:
in a state where application specifies a receivable movement of an object, when a movement of an object which is different from the receivable movement is detected, neglect the detected movement of the object.
   (14) The information processing apparatus according to any one of (1) to (13), wherein

a detection region includes a plurality of divided regions, and

the processing unit is further configured to:
determine whether or not an operation body is detected based on whether or not at least one operation body is detected in each of the plurality of divided regions.
   (15) The information processing apparatus according to any one of (1) to (14), further comprising:

an acquisition unit that downloads, from another device, a program that causes a computer to function as the processing unit.

(16) The information processing apparatus according to (15), wherein

the processing unit is integrated into a detection device that detects the first object, and

the acquisition unit acquires the program from a terminal device connected to the detection device or a server configured to communicate with the terminal device via a network.

(17) The information processing apparatus according to (15), wherein

the processing unit is integrated into a terminal device connected to a detection device that detects the first object, and

the acquisition unit acquires the program from a server configured to communicate with the terminal device via a network.

(18) The information processing apparatus according to any one of (1) to (14), wherein

the processing unit is integrated into a server configured to communicate, via a network, with a terminal device connected to a detection device that detects the first object.

(19) An information processing method allowing a processor to execute the following step:

when identification information of a first object that is detected at a first timing is read and further when identification information of a second object that is detected at a second timing different from the first timing is not read, determining that the first object and the second object are a same to each other.

(20) A program allowing a computer to function as:

an information processing apparatus including:
a processing unit that determines, when identification information of a first object that is detected at a first timing is read and further when identification information of a second object that is detected at a second timing different from the first timing is not read, that the first object and the second object are a same to each other.

### REFERENCE SIGNS LIST

100 information processing system
200 game console
210 input unit
220 wireless communication unit
230 control unit
231 acquisition unit
232 processing unit
240 storage
250 communication unit
260 output unit
300 pad device
310 control unit
320 wireless communication unit
340 non-contact communication unit
350 security tip
400 card
401 RFID tag
420 control unit
430 storage
440 non-contact communication unit
500 server device
510 control unit
520 storage
530 communication unit
600 network

1. An information processing apparatus comprising:
a processing unit configured to:
when identification information of a first object that is detected at a first timing is read and further when identification information of a second object that is detected at a second timing different from the first timing is not read, determine that the first object and the second object are a same to each other.

2. The information processing apparatus according to claim 1, wherein
the second timing is a timing at which an object state is changed after the first timing.

3. The information processing apparatus according to claim 1, wherein
the first timing is a timing at which an object state is changed after the second timing.

4. The information processing apparatus according to claim 1, wherein
the processing unit is further configured to:
employ the identification information of the first object as the identification information of the second object to determine that the first object and the second object are a same to each other.

5. The information processing apparatus according to claim 1, wherein
the processing unit is further configured to:
when identification information of a third object that is detected at a third timing and identification information of a fourth object that is detected at a fourth timing are a same to each other, determine that a fifth object that is detected at the third timing and a sixth object that is detected at the fourth timing are a same to each other.

6. The information processing apparatus according to claim 1, wherein
the processing unit is further configured to:
when identification information of a plurality of objects that is detected at a third timing is read and identification information of at least one object that is detected at a fourth timing is not read, based on coordinates of the plurality of objects and a coordinate of the at least one object, search the plurality of objects for an object that is a same as the at least one object.

7. The information processing apparatus according to claim 1, wherein
the processing unit is further configured to:
when identification information of a plurality of third objects that is detected at a third timing is not read and identification information of a plurality of fourth objects that is detected at a fourth timing is read, not employ the identification information of the plurality of fourth objects as the identification information of the plurality of third objects.

8. The information processing apparatus according to claim 1, wherein
the processing unit is further configured to:
when identification information of a plurality of third objects that is detected at a third timing is read and identification information of a plurality of fourth objects that is detected at a fourth timing is not read, not employ the identification information of the plurality of third objects as the identification information of the plurality of fourth objects.

9. The information processing apparatus according to claim 1, wherein
the processing unit is further configured to:
when pieces of identification information read from a third object and a fourth object that are detected at a third timing are a same to each other, determine that the respective pieces of identification information of the third object and the fourth object are not read.

10. The information processing apparatus according to claim 1, wherein
a first detection region and a second detection region logically form a single coordinate space, and
the processing unit is further configured to:
when a time interval from a timing at which a third object goes out of detection in the first detection region until a timing at which a fourth object is detected in the second detection region is within a predetermined time interval, determine that the third object presents in the first detection region.

11. The information processing apparatus according to claim 1, wherein
a first detection region and a second detection region logically form a single coordinate space, and
the processing unit is further configured to:
when a fourth object is detected in the second detection region before a third object goes out of detection in the first detection region, not employ a position of the third object which is detected in the first detection region after the fourth object is detected in the second detection region.

12. The information processing apparatus according to claim 1, wherein
a first detection region and a second detection region logically form a single coordinate space, and
the processing unit is further configured to:
when one or more objects including a third object are detected in a boundary region of the first detection region and the second detection region, determine whether or not a number of the one or more objects is plural based on whether or not lengths of the one or more objects in a predetermined direction are larger than a predetermined length according to an orientation of the third object.

13. The information processing apparatus according to claim 1, wherein
the processing unit is further configured to:
in a state where application specifies a receivable movement of an object, when a movement of an object which is different from the receivable movement is detected, neglect the detected movement of the object.

14. The information processing apparatus according to claim 1, wherein
a detection region includes a plurality of divided regions, and
the processing unit is further configured to:
determine whether or not an operation body is detected based on whether or not at least one operation body is detected in each of the plurality of divided regions.

15. The information processing apparatus according to claim 1, further comprising:
an acquisition unit that downloads, from another device, a program that causes a computer to function as the processing unit.

16. The information processing apparatus according to claim 15, wherein
the processing unit is integrated into a detection device that detects the first object, and
the acquisition unit acquires the program from a terminal device connected to the detection device or a server configured to communicate with the terminal device via a network.

17. The information processing apparatus according to claim 15, wherein
the processing unit is integrated into a terminal device connected to a detection device that detects the first object, and
the acquisition unit acquires the program from a server configured to communicate with the terminal device via a network.

18. The information processing apparatus according to claim 1, wherein
the processing unit is integrated into a server configured to communicate, via a network, with a terminal device connected to a detection device that detects the first object.

19. An information processing method allowing a processor to execute the following step:
when identification information of a first object that is detected at a first timing is read and further when identification information of a second object that is detected at a second timing different from the first timing is not read, determining that the first object and the second object are a same to each other.

20. A program allowing a computer to function as:
an information processing apparatus including:
a processing unit that determines, when identification information of a first object that is detected at a first timing is read and further when identification information of a second object that is detected at a second timing different from the first timing is not read, that the first object and the second object are a same to each other.
